(19) United States
(12) Patent Application Publication
(10) Pub. No.: US 2025/0154728 A1
(43) Pub. Date: May 15, 2025

(54) RECYCLABLE, THERMOFORMABLE PAPER BASE WEB

(71) Applicant: PROAMPAC HOLDINGS INC., Cincinnati, OH (US)

(72) Inventors: Adam West, Falcarragh (IE); Raymond J. Recchia, Cincinnati, OH (US); Lynsey A. Maddison, Grimsby (GB); James E. Tierney, South Hadley, MA (US); Terry J. Leis, Huntington, MA (US); Seyed Hesamoddin Tabatabaei, Mason, OH (US); Amir Saffar, Laval (CA)

(21) Appl. No.: 18/937,558

(22) Filed: Nov. 5, 2024

Related U.S. Application Data
(60) Provisional application No. 63/548,327, filed on Nov. 13, 2023.

(51) Int. Cl. D21H 27/30; B32B 7/12; B32B 27/10; B32B 27/30; B32B 27/32; B32B 29/00

(52) U.S. Cl. CPC D21H 27/30; B32B 7/12; B32B 27/10; B32B 27/306; B32B 27/32; B32B 29/005; B32B 2250/03; B32B 2307/308; B32B 2307/718; B32B 2553/00

(57) ABSTRACT

A thermoformable paper base web comprises an outer paper layer having opposing first and second surfaces, the second surface defining an exterior facing surface of the paper base web. An inner paper layer has opposing first and second surfaces, the first surface laminated to the second surface of the outer paper layer. A first bonding layer joins the outer paper layer second surface to the inner paper layer first surface. A polymer layer has opposing first surface and second surfaces, wherein the second surface of the polymer layer defines an interior-facing surface of the paper base web. The first surface of the polymer layer is joined to the second surface of the inner paper layer. The outer and inner paper layers together comprise at least 80% by weight of the thermoformable paper base web and less than 100% by weight of the thermoformable paper base web.

### CROSS REFERENCE TO RELATED APPLICATION

This application claims the priority benefit of U.S. provisional application No. 63/548,327 filed Nov. 13, 2023. The aforementioned application is incorporated herein by reference in its entirety.

### BACKGROUND

The present disclosure relates generally to the field of thermoformed packaging and, more particularly, recyclable, paper-based, thermoformable base web materials, thermoformed packaging articles made therefrom, and method of forming the same.

Thermoformed packaging trays have found practical utility in the packaging of various consumable products, including perishable food products such as chilled cooked meats and others. Thermoformed packaging structures made from laminated films of paper and polymer such as polyethylene are known. Such packaging structures may also include a gas barrier layer such as ethylene-vinyl alcohol copolymer (EVOH) to limit the ingress of oxygen into the packaging. Such gas barrier also provides additional moisture resistance by reducing the transmission of moisture vapor transmission through the packaging material.

Such structures have generally provided a functional and cost-effective solution for the containment, transportation, and display of such products. However, existing paper and polymer laminated structures are typically nonrecyclable in paper recycling streams, thereby presenting environmental and sustainability concerns.

Attempts to create a recyclable, thermoformable paper base web have encountered challenges and limitations. For instance, attempts to increase the paper content and/or reduce the polymer content have resulted in base web materials that cannot be formed to a sufficient depth without the material tearing. Shifting the proportions of paper and polymer to support recyclability while maintaining adequate form depth and structural integrity of the paper base web packaging structure during manufacture and use has, heretofore, not been accomplished.

The present disclosure provides new and improved paper base webs, thermoformed packaging articles produced therefrom, and methods for making the same, which overcome the above-referenced problems and others.

### SUMMARY

In one aspect, a thermoformable paper base web comprises an outer paper layer having a first surface and a second surface opposite the first surface, wherein the first surface of the outer paper layer defines an exterior-facing surface of the paper base web. An inner paper layer has a first surface and a second surface opposite the first surface, wherein the first surface of the inner paper layer is laminated to the second surface of the outer paper layer. A first bonding layer is disposed between the outer paper layer and inner paper layer, wherein the first bonding layer joins the second surface of the outer paper layer to the first surface of the inner paper layer. A polymer layer has a first surface and a second surface opposite the first surface, wherein the second surface of the polymer layer defines an interior-facing surface of the paper base web and the first surface of the polymer layer is joined to the second surface of the inner paper layer. The outer and inner paper layers together comprise at least 80% by weight of the thermoformable paper base web and less than 100% by weight of the thermoformable paper base web.

In a more limited aspect, the first bonding layer is attached directly to the second surface of the outer paper layer and the first surface of the inner paper layer.

In another more limited aspect, the first bonding layer is selected from the group consisting of an adhesive layer and an extruded resin layer.

In another more limited aspect, the polymer layer is selected from the group consisting of monolayer film and a multilayer film.

In another more limited aspect, the polymer layer is attached directly to the second surface of the inner paper layer.

In another more limited aspect, the thermoformable paper base web further comprises a second bonding layer between the inner paper layer and the polymer layer, the second bonding layer joining the second surface of the inner paper layer to the first surface of the polymer layer.

In another more limited aspect, the second bonding layer is attached directly to the second surface of the inner paper layer and the first surface of the polymer layer.

In another more limited aspect, the second bonding layer is an adhesive layer and the inner paper layer is laminated with the polymer layer via the adhesive layer.

In another more limited aspect, the polymer layer is selected from the group consisting of a barrier film layer and a nonbarrier film layer.

In another more limited aspect, the outer paper layer and the inner paper layer, which may be the same or different, each comprise paper having a basis weight in the range of 50 GSM to 300 GSM.

In another more limited aspect, the polymer layer is selected from the group consisting of: (a) a first coextruded film comprising a first polyolefin layer, a second polyolefin layer, and a first barrier layer disposed intermediate the first and second polyolefin layers, wherein the first barrier layer is formed of a material selected from the group consisting of ethylene-vinyl alcohol copolymer (EVOH), polyvinylidene di-chloride (PVcD), polyamide, and polyvinyl alcohol (PVOH); and (b) a second coextruded film comprising a second barrier layer having a barrier outer surface coupled to the second surface of the inner paper layer and a barrier inner surface opposite the barrier outer surface, and a third polyolefin layer coupled to the barrier inner surface.

In another more limited aspect, the first and second barrier layers comprise EVOH and the first, second, and third polyolefin layers, which may be the same or different, comprise a polyethylene-based polymer.

In another more limited aspect, the first bonding layer is selected from the group consisting of: (a) an adhesive layer formed of an adhesive selected from the group consisting of a high viscosity adhesive having a viscosity in the range of 300 cP to 500,000 cP at 50 degrees C.; (b) a high solids content adhesive having a solids content in the range of 15% to 100% by weight; and (c) an extruded polyolefin resin layer.

In another more limited aspect, the first bonding layer is selected from the group consisting of: (a) a third coextruded film comprising a fourth polyolefin layer, a fifth polyolefin layer, and a third barrier layer disposed intermediate the fourth and fifth polyolefin layers, wherein the third barrier layer is formed of a material selected from the group consisting of ethylene-vinyl alcohol copolymer (EVOH), polyvinylidene di-chloride (PVcD), polyamide, and polyvinyl alcohol (PVOH); and (b) a fourth coextruded film comprising a fourth barrier layer having a barrier inner surface coupled to the first surface of the inner paper layer and a barrier outer surface opposite the barrier inner surface, and a sixth polyolefin layer coupled to the barrier outer surface and the second surface of the outer paper layer.

In another more limited aspect, the third and fourth barrier layers comprise EVOH and the fourth, fifth, and sixth polyolefin layers, which may be the same or different, comprise a polyethylene-based polymer.

In another more limited aspect, the paper base web is thermoformable to a depth of between 1 mm to 153 mm.

In another more limited aspect, said outer and inner paper layers together comprise at least 85% by weight of the thermoformable paper base web and less than 100% by weight of the thermoformable paper base web.

In another more limited aspect, said outer and inner paper layers together comprise at least 90% by weight of the thermoformable paper base web and less than 100% by weight of the thermoformable paper base web.

In another more limited aspect, said outer and inner paper layers together comprise at least 95% by weight of the thermoformable paper base web and less than 100% by weight of the thermoformable paper base web.

In another aspect, a method for producing a thermoformable paper base web comprises laminating an outer paper layer to an inner paper layer with a first bonding layer therebetween, the outer paper layer having a first surface and a second surface opposite the first surface, wherein the first surface of the outer paper layer defines an exterior-facing surface of the paper base web. In embodiments, the first surface of the outer paper layer defines an exterior-most surface of the paper base web. The inner paper layer has a first surface and a second surface opposite the first surface and the first surface of the inner paper layer faces second surface of the outer paper layer. A polymer layer is attached to the second surface of the inner paper layer, the polymer layer having a first surface and a second surface opposite the first surface, wherein the first surface of the polymer layer is joined to the second surface of the inner paper layer and the second surface of the polymer layer defines an interior-facing surface of the paper base web. In embodiments the second surface of the polymer layer defines an interior-most surface of the paper base web The outer and inner paper layers together comprise at least 80% by weight of the thermoformable paper base web and less than 100% by weight of the thermoformable paper base web.

In a more limited aspect, the first bonding layer is attached directly to the second surface of the outer paper layer and the first surface of the inner paper layer.

In another more limited aspect, the first bonding layer is selected from the group consisting of an adhesive layer and an extruded resin layer.

In another more limited aspect, the first bonding layer is selected from the group consisting of: (a) a high viscosity adhesive having a viscosity in the range of 300 cP to 500,000 cP at 50 degrees C.; (b) a high solids content adhesive having a solids content in the range of 15% to 100% by weight; and (c) an extruded polyolefin resin layer.

In another more limited aspect, the step of attaching the polymer layer to the second surface of the inner paper layer is performed by a process selected from the group consisting of adhesive lamination and extrusion lamination.

In another more limited aspect, the step of attaching the polymer layer to the second surface of the inner paper layer includes applying a second bonding layer between the inner paper layer and the polymer layer, the second bonding layer joining the second surface of the inner paper layer to the first surface of the polymer layer.

In another more limited aspect, the second bonding layer is selected from the group consisting of an adhesive layer and an extruded resin layer.

In another more limited aspect, the second bonding layer is selected from the group consisting of: (a) a high viscosity adhesive having a viscosity in the range of 300 cP to 500,000 cP at 50 degrees C.; (b) a high solids content adhesive having a solids content in the range of 15% to 100% by weight; and (c) an extruded polyolefin resin layer.

In another more limited aspect, the second bonding layer is attached directly to the second surface of the inner paper layer and the first surface of the polymer layer.

In another more limited aspect, the polymer layer is applied to the second surface of the inner paper layer using a method selected from the group consisting of an extrusion coating process and a coextrusion coating process.

In another more limited aspect, the polymer layer is selected from the group consisting of monolayer film and a multilayer film.

In another more limited aspect, the polymer layer is selected from the group consisting of a barrier film layer and a nonbarrier film layer.

In another more limited aspect, the polymer layer is selected from the group consisting of a barrier film layer and a nonbarrier film layer.

In another more limited aspect, the polymer layer is selected from the group consisting of:

a first coextruded film comprising a first polyolefin layer, a second polyolefin layer, and a first barrier layer disposed intermediate the first and second polyolefin layers, wherein the first barrier layer is formed of a material selected from the group consisting of ethylene-vinyl alcohol copolymer (EVOH), polyvinylidene di-chloride (PVcD), polyamide, and polyvinyl alcohol (PVOH); and
a second coextruded film comprising a second barrier layer having a barrier outer surface coupled to the second surface of the inner paper layer and a barrier inner surface opposite the barrier outer surface, and a third polyolefin layer coupled to the barrier inner surface.

In another more limited aspect, the first and second barrier layers comprise EVOH and the first, second, and third polyolefin layers, which may be the same or different, comprise a polyethylene-based polymer.

In another more limited aspect, the first bonding layer is selected from the group consisting of: (a) an adhesive layer formed of an adhesive selected from the group consisting of a high viscosity adhesive having a viscosity in the range of 300 cP to 500,000 cP at 50 degrees C.; (b) a high solids content adhesive having a solids content in the range of 15% to 100% by weight; and (c) an extruded polyolefin resin layer.

In another more limited aspect, the first bonding layer is selected from the group consisting of: (a) a third coextruded film comprising a fourth polyolefin layer, a fifth polyolefin layer, and a third barrier layer disposed intermediate the fourth and fifth polyolefin layers, wherein the third barrier layer is formed of a material selected from the group consisting of ethylene-vinyl alcohol copolymer (EVOH), polyvinylidene di-chloride (PVcD), polyamide, and polyvinyl alcohol (PVOH); and (b) a fourth coextruded film comprising a fourth barrier layer having a barrier inner surface coupled to the first surface of the inner paper layer and a barrier outer surface opposite the barrier inner surface, and a sixth polyolefin layer coupled to the barrier outer surface and the second surface of the outer paper layer.

In another more limited aspect, the third and fourth barrier layers comprise EVOH and the fourth, fifth, and sixth polyolefin layers, which may be the same or different, comprise a polyethylene-based polymer.

In another more limited aspect, the method further comprises modifying one or more of the second surface of the outer paper layer, the first surface of the inner paper layer, the second surface of the inner paper layer, and the inner surface of the polymer layer with a surface treatment selected from the group consisting of flame treatment, corona treatment, ozone treatment, and plasma treatment.

In a further aspect, a thermoformed packaging article formed from the paper base web in accordance with this disclosure is provided.

In a more limited aspect, the thermoformed packaging article is a packaging tray.

In a further aspect, a thermoformed packaging article formed via the method in accordance with this disclosure is provided.

In another aspect, the present disclosure relates to a paper base web structure comprising, in order, an outer paper layer, a first bonding layer, an inner paper layer, a second adhesive layer, and a polymer layer. Each of the outer paper layer and the polymer layer has an outer surface that are the opposing external surfaces of the paper base web structure. In embodiments, the outer and inner paper layers together represent at least 80% by weight of the paper base web structure and less than 100% by weight of the paper base web structure, so that the paper base web structure is recyclable in paper recycling streams. In embodiments, the outer and inner paper layers together comprise at least 85% by weight of the thermoformable paper base web and less than 100% by weight of the thermoformable paper base web. In embodiments, the outer and inner paper layers together comprise at least 90% by weight of the thermoformable paper base web and less than 100% by weight of the thermoformable paper base web. In embodiments, the outer and inner paper layers together comprise at least 95% by weight of the thermoformable paper base web and less than 100% by weight of the thermoformable paper base web. In embodiments, the outer and inner paper layers together comprise at least 80% by weight of the thermoformable paper base web and less or equal to 95% by weight of the thermoformable paper base web. This paper base web structure is an adhesive lamination embodiment of the present invention.

In a more limited aspect, the paper base web structure has a basis weight, as measured by a micrometer test method, of 327.8±10% GSM; an oxygen transmission rate (OTR) as measured utilizing the ASTM D3895 test method at standard test conditions of 23° C. and 0% relative humidity (RH) of ≤2.2±5% cc/m²/24 hours; and a water vapor transmission rate (WVTR) as measured utilizing the ASTM F1249 test method at standard test conditions of 38° C. and 90% RH of ≤8.9±5% g/m²/24 hours.

In another more limited aspect, each of the outer and inner paper layers has a basis weight of between 50 and 300 GSM, preferably between 100 and 150 GSM.

In another more limited aspect, the outer and inner paper layers are made of thermoformable paper, meaning the paper layers have been molded with heat and vacuum. The thermoform molding process affects the form depth or draw depth of the paper. Form depth/draw depth is the maximum height that a three-dimensional structure can be formed from a sheet, i.e., its stretchability. The paper base web preferably has a form depth of between 1 and 153 mm, preferably 21 mm.

In embodiments the thermoformable paper is a stretchable paper having a stretchability of 5% to 25% in a first predetermined direction in the range, and more preferably 10% or more, and a stretchability of 5% to 25% in a second predetermined direction which is perpendicular to the first predetermined direction, and more preferably 13% or more. In embodiments, the first predetermined direction is the machine direction (MD) and the second predetermined direction is the transverse direction (TD)

Exemplary paper out of which the outer and inner paper layers are formed is sold commercially under the trademark BILLERUD FIBREFORM™ (Billerud AB, Solna, Sweden).

In another more limited aspect, the first bonding layer is comprised of a solvent-free high viscosity adhesive with a centipoise value of between 300 cP and 500,000 cP at 50 degrees C. and/or high solids content adhesive, e.g., having a solids content of between 15% and 100%, preferably 30% to 100%, and more preferably 100% or nearly 100%, by weight. An exemplary first bonding layer preferably has 100% solids content and a viscosity of 1000 cP at room temperature.

In another more limited aspect, the second adhesive layer is a solvent-free adhesive, and may be a low, medium, or high viscosity adhesive.

In another more limited aspect, the polymer layer is a coextruded film layer that comprises at least, in order, a first polyolefin layer adjacent to the second adhesive layer; a first tie layer; a barrier layer; a second tie layer; and a second polyolefin layer, whose external surface is the external surface of the paper base web structure. The preferred first and second polyolefin layers are polyethylene layers. The barrier layer is preferably an EVOH layer. A preferred coextruded polymer layer has a thickness of 27.8 GSM. A preferred coextruded polymer film layer is that sold under the trademark VIZELPAS. Polymer layers that are coextrusion layers including a barrier layer are preferred for food, especially meat, packaging applications where oxygen and moisture permeation must be carefully limited.

In another more limited aspect, the polymer layer is a nonbarrier layer, such as polyethylene, polypropylene, or other suitable polymer material. Nonbarrier polymer layers are advantageously suited for applications that do not involve perishable food packaging or where a high level of protection against gas (e.g., oxygen) permeation is not required.

During production of the paper base web structures herein, treatments may be applied to the various layers for surface modification. Such treatments may be, non-exclusively, flame, ozone, corona, or plasma treatments and may be deployed to imbue the surfaces with adhesion promotion characteristics.

In another aspect, the present disclosure relates to a paper base web structure comprising, in order, an outer paper layer, an extrusion layer, an inner paper layer, and a polymer layer. Each of the outer paper layer and the polymer layer has an outer surface that are the opposing outer surfaces of the paper base web structure. In embodiments, the outer and inner paper layers together represent at least 80% by weight of the paper base web structure and less than 100% by weight of the paper base web structure, so that the paper base web structure is recyclable in paper recycling streams. In embodiments, the outer and inner paper layers together comprise at least 85% by weight of the thermoformable paper base web and less than 100% by weight of the thermoformable paper base web. In embodiments, the outer and inner paper layers together comprise at least 90% by weight of the thermoformable paper base web and less than 100% by weight of the thermoformable paper base web. In embodiments, the outer and inner paper layers together comprise at least 95% by weight of the thermoformable paper base web and less than 100% by weight of the thermoformable paper base web. In embodiments, the outer and inner paper layers together comprise at least 80% by weight of the thermoformable paper base web and less or equal to 95% by weight of the thermoformable paper base web. In embodiments, the outer and inner paper layers together comprise at least 85% by weight of the thermoformable paper base web and less than 100% by weight of the thermoformable paper base web. In embodiments, the outer and inner paper layers together comprise at least 90% by weight of the thermoformable paper base web and less than 100% by weight of the thermoformable paper base web. In embodiments, the outer and inner paper layers together comprise at least 95% by weight of the thermoformable paper base web and less than 100% by weight of the thermoformable paper base web. In embodiments, the outer and inner paper layers together comprise at least 80% by weight of the thermoformable paper base web and less or equal to 95% by weight of the thermoformable paper base web. This paper base web structure is an extrusion embodiment of the present development.

In another more limited aspect, an extrusion embodiment of the paper base web structure has the following structure: 150 GSM Paper/Extruded 8 GSM PE/100 GSM Paper/16 GSM PE-EVOH-PE coextrusion coating. In this example, the structure has a basis weight of 274 GSM; an OTR as measured utilizing the ASTM D3895 test method at standard test conditions of 23° C. and 0% RH of ≤2.2±5% cc/m²/24 hours; and a WVTR as measured utilizing the ASTM F1249 test method at standard test conditions of 38° C. and 90% RH of ≤8.9±5% g/m²/24 hours.

In another more limited aspect, each of the outer and inner paper layers has a basis weight of between 50 and 300 GSM. In certain embodiments, the outer paper layer has a basis weight of 150 GSM. In certain embodiments, the inner paper layer has a basis weight of 100 GSM.

In another more limited aspect, the outer and inner paper layers are made of thermoformable paper. In embodiments, the paper base web has a form depth of between 1 and 153 mm, preferably 21 mm. In embodiments, the paper has a stretch in the range of 5%-25% in the machine direction, preferably 10% or more, and 5%-25% in the transverse direction, preferably 13% or more. Exemplary paper out of which the first and second layers are formed is sold commercially under the trademarks BILLERUD FIBREFORM.

In another more limited aspect, the extrusion layer is polyethylene having a thickness of 8 GSM.

In another more limited aspect, the polymer layer is a coextrusion coating layer that comprises at least, in order, a first polyolefin layer adjacent to the inner paper layer; a first tie layer; a barrier layer; a second tie layer; and a second polyolefin layer, whose outer surface defines an outer surface, i.e., interior-facing surface of the paper base web structure. In embodiments, the first and second polyolefin layers are formed of polyethylene. In embodiments, the barrier layer is formed of EVOH layer. In embodiments, the polymer layer coextrusion coating has a basis weight or coating density of 16 GSM.

In another more limited aspect, the polymer layer is a coextruded film layer that comprises in order, an EVOH barrier layer directly adjacent to the inner paper layer, a polyolefin layer, e.g., polyethylene, and a tie layer. The tie layer is intermediate the EVOH barrier layer and the polyolefin layer. The external surface of the polyolefin layer defines an external surface of the paper base web structure.

In another more limited aspect, the polymer layer is a nonbarrier layer formed of polyethylene or other suitable polymer. Embodiments having a nonbarrier polymer layer are advantageously suited for applications that do not involve perishable food packaging or where a high level of protection against gas (e.g., oxygen) permeation is not required.

In another aspect, a method for producing an adhesive lamination embodiment of the paper base webs as described above is provided. In its most basic form, the method includes the steps of providing the outer and inner paper layers; disposing a first bonding layer, e.g., a high viscosity and/or high solids content adhesive between the outer and inner paper layers to form a paper adhesive lamination; providing a polymer film layer; and disposing a second adhesive between the paper lamination and the polymer layer, where the outer and inner paper layers together comprise at least 80% by weight of the resultant paper base web structure and less than 100% by weight of the paper base web structure. In embodiments, the outer and inner paper layers together comprise at least 85% by weight of the thermoformable paper base web and less than 100% by weight of the thermoformable paper base web. In embodiments, the outer and inner paper layers together comprise at least 90% by weight of the thermoformable paper base web and less than 100% by weight of the thermoformable paper base web. In embodiments, the outer and inner paper layers together comprise at least 95% by weight of the thermoformable paper base web and less than 100% by weight of the thermoformable paper base web. In embodiments, the outer and inner paper layers together comprise at least 80% by weight of the thermoformable paper base web and less or equal to 95% by weight of the thermoformable paper base web.

In another more limited aspect, the method includes the step of modifying one or more of the surfaces to be adhesively bonded of the outer paper layer, the inner paper layer, and/or the polymer layer. This surface modification may be, non-exclusively, through flame, ozone, corona, or plasma treatment to promote adhesion.

In embodiments, the polymer layer is a coextruded barrier film comprising a first polyethylene layer, a first tie layer, an EVOH layer, a second tie layer, and a second polyethylene layer, i.e., a five layer barrier coextrusion. It will be recognized that other numbers of layers, such as seven layer barrier coextrusions, nine layer coextrusions, and so forth are also contemplated.

In another more limited aspect, the method includes the optional steps of drying the paper lamination after disposing the high viscosity and/or high solids content adhesive between the outer and inner paper layers and/or drying the paper base web structure after disposing the adhesive between the paper lamination and the coextrusion layer.

In another more limited aspect, the method includes the steps of compressing the outer and inner paper layers through nip or pressure rollers after disposing the first bonding layer between the outer and inner paper layers.

In yet another aspect, another method for producing an extrusion embodiment of the paper base web structure, as described above, is provided. In its most basic form, the steps of this method include: providing outer and inner paper layers; bonding the outer and inner paper layers via extrusion lamination with a polyolefin, e.g., polyethylene; and coating the inner paper layer with a polymer layer via extrusion coating (in the case of a single layer polymer layer) or via coextrusion coating (in the case of a coextruded multilayer polymer layer) to form an extrusion embodiment paper base web structure.

In another more limited aspect, the polymer layer is a coextrusion coating layer comprising polyethylene, a tie resin, and EVOH forming, e.g., a PE-Tie Resin-EVOH-Tie Resin-PE coextrusion coating, i.e., a five layer barrier coextrusion. It will be recognized that other numbers of layers, such as seven layer barrier coextrusions, nine layer coextrusions, and so forth are also contemplated.

Certain advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a cross-sectional diagram illustrating a composite structure operable to embody the thermoformable paper base web structure of the present disclosure.

FIG. 2 is a cross-sectional diagram illustrating the layers of an exemplary adhesive lamination embodiment of the paper base web structure.

FIG. 3 is a cross-sectional diagram of an exemplary adhesive lamination embodiment having a coextruded barrier film polymer layer.

FIG. 4 is a cross-sectional diagram of an exemplary adhesive lamination embodiment having a nonbarrier polymer layer.

FIG. 5 is a cross-sectional diagram illustrating the layers of an exemplary extrusion embodiment of the paper base web structure.

FIG. 6A is a cross-sectional diagram of a first exemplary extrusion embodiment wherein the polymer layer is barrier film coextrusion coating.

FIG. 6B is a cross-sectional diagram of a first exemplary extrusion embodiment wherein the polymer layer is barrier film coextrusion coating.

FIG. 7A is a cross-sectional diagram of an exemplary extrusion embodiment wherein the polymer layer is a nonbarrier extrusion coating or coextrusion coating.

FIG. 7B is a cross-sectional diagram illustrating a first more specific embodiment of the structure appearing in FIG. 7A.

FIG. 7C is a cross-sectional diagram illustrating a second more specific embodiment of the structure appearing in FIG. 7A.

FIG. 8A is a cross-sectional diagram of an exemplary extrusion embodiment wherein the polymer layer is a coextruded barrier film polymer layer.

FIG. 8B is a cross-sectional diagram illustrating a first more specific embodiment of the structure appearing in FIG. 8A.

FIG. 8C is a cross-sectional diagram illustrating a second more specific embodiment of the structure appearing in FIG. 8A.

FIG. 8D is a cross-sectional diagram illustrating a third more specific embodiment of the structure appearing in FIG. 8A.

FIG. 8E is a cross-sectional diagram illustrating a fourth more specific embodiment of the structure appearing in FIG. 8A.

FIG. 9A is a cross-sectional diagram illustrating a first exemplary embodiment paper base web having a moisture barrier layer on the exterior side of the outer paper layer.

FIG. 9B is a cross-sectional diagram illustrating a second exemplary embodiment paper base web having a moisture barrier layer on the exterior side of the outer paper layer.

FIG. 10 is a flow chart illustrating the steps of an exemplary method for producing an adhesive lamination embodiment of the paper base web structure.

FIG. 11 is a more detailed flow chart illustrating the steps of the method for producing an adhesive lamination embodiment of the paper base web structure.

FIG. 12A is a schematic drawing of an exemplary process line for a first step of a two-step process for producing an adhesive lamination embodiment of the paper base web structure.

FIG. 12B is a schematic drawing of an exemplary process line for a second step of a two-step process for producing an adhesive lamination embodiment of the paper base web structure.

FIG. 12C is a schematic drawing of an exemplary process line for producing an adhesive lamination embodiment of the paper base web structure in a single step process.

FIG. 12D is a schematic drawing of an exemplary process line for producing an adhesive lamination embodiment of the paper base web structure in an alternative single step process.

FIG. 13 is a flow chart illustrating the steps of a method for producing an extrusion embodiment of the paper base web structure.

FIG. 14A is a schematic drawing of an exemplary process line for a first step of a two-step process for producing an extrusion embodiment of the paper base web structure.

FIG. 14B is a schematic drawing of an exemplary process line for a second step of a two-step process for producing an extrusion embodiment of the paper base web structure.

FIG. 14C is a schematic drawing of an exemplary process line for producing an adhesive lamination embodiment of the paper base web structure in a single step process.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

The terms “exterior” and “interior” are used herein to refer to a position in relation to a product to be packaged using the multilayer packaging structures herein, while the terms “outer” and “inner” are used herein to refer to a position in relation to other layers of the multilayer packaging structures herein.

As used herein, the term “exterior layer” refers to a layer of a multilayer packaging structure which is furthest from the product to be packaged in relation to the other layers of the multilayer structure. The term “exterior facing surface” of a layer of a multilayer packaging structure is the surface of such layer that faces away from the product being packaged within a multilayer packaging structure herein or a packaging article formed thereof. Likewise, the term “exterior surface” of a multilayer packaging structure is the surface of the structure that is intended to face away from a product being packaged within the structure. The term “exterior-most surface” refers to the surface of the outer paper layer that is intended to be the furthest away from a packaged product when the paper base web is formed into a packaging article. In embodiments, the exterior surface of the outer paper layer is the outermost surface of the paper base web. In certain embodiments, a moisture barrier layer may be disposed on the exterior surface of the outer paper layer.

As used herein, the term “interior layer” refers to a layer of a multilayer packaging structure which is closest to or is intended to contact the product to be packaged within a multilayer structure herein in relation to the other layers of the multilayer structure. The term “interior facing surface” of a layer of a multilayer packaging structure herein is the surface of such layer that faces toward the product being packaged within a multilayer packaging structure herein or a packaging article formed thereof. Likewise, the term “interior surface” of a multilayer packaging structure herein is the surface of the structure that faces toward or is intended to face toward or contact a product being packaged within the structure. The term “interior-most surface” refers to the surface of the polymer layer that is intended to be closest to a packaged product when the paper base web is formed into a packaging article.

As used herein, the term “inner layer” refers to a layer within a multilayer packaging structure that is not exposed to handling and the environment. Inner layers may provide functionality as needed for particular applications. For example, inner layers may provide barrier protection and/or structural strength. As an example, an exemplary inner layer provides protection to packaged food or other product for freshness and/or a barrier to moisture and/or oxygen, and/or a barrier to migration of moisture, oils, and the like from packaged food or other product from the interior surface of the multilayer packaging structure to the exterior surface of the multilayer packaging structure. As another example, an inner layer may also be a structural layer which provides one or more properties including but not limited to general durability, puncture strength, resistance to curling, tear or flex crack resistance, and the like.

As used herein, the term “outer layer” refers to a layer which comes in immediate contact with the outside environment or atmosphere. Therefore, the multilayer packaging structures herein have two outer layers, namely, the interior layer and the exterior layer.

As used herein, “recyclable” may refer to a paper-based product that is eligible for acceptance into paper recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability.

As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

As used herein, the terms “grease resistant” or “grease resistance” refer to the character of the barrier layer in blocking or impeding the absorption or transmission of grease or oil in any significant quantity.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the term “surface treatment” means a surface modification treatment to increase the surface energy of a material, which can improve adhesion between two surfaces.

As used herein, the term “packaging structure” means a web of sheet material having a structure as disclosed herein, as well as a packaging article manufactured therefrom, including sheets or wraps, bags, pouches, and the like.

As used herein “fiber components” refers to the paper material in a composite, including any cellulose fibers or pulp.

As used herein, “non-fiber components” refers to non-paper material in a composite, including any polymer films, coatings, lamination adhesives, or any other non-paper elements in the composite.

All compositional percentages used herein are presented on a “by weight” basis, unless specifically stated otherwise.

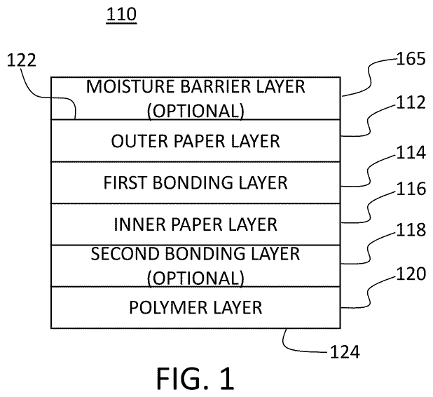

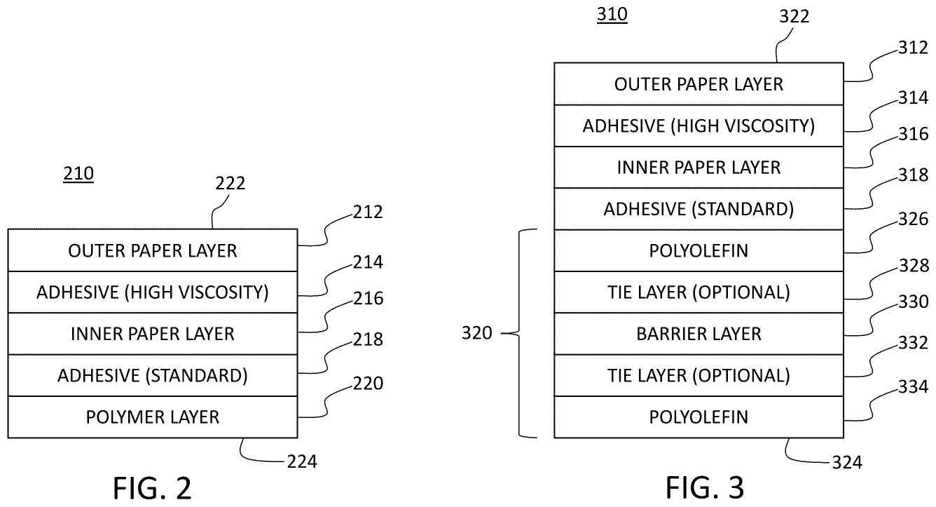

Referring now to the drawings, like reference numerals are used to describe like or analogous items in which the hundreds digit has been increased to correspond to the figure number (e.g., the outer paper layer 112 in FIG. 1 corresponds to the outer paper layer 212 in FIG. 2, which corresponds to the outer paper layer 312 in FIG. 3, and so forth). The description in reference to any given reference numeral herein is equally applicable to other reference numerals that differ only in the hundreds digit, unless specifically stated otherwise.

Referring now to FIG. 1 there is illustrated a cross-sectional view of a general embodiment of a paper base web structure 110. The structure 110 includes an outer paper layer 112 and an inner paper layer 116. The outer paper layer 112 defines an outward facing surface 122 of the structure 110. A first bonding layer 114 is disposed between the inner and outer paper layers 112, 116. In embodiments the first bonding layer 114 may be an adhesive layer or an extruded resin layer, as described in greater detail below. The inner and outer paper layers 112, 116 may be brought together via an adhesive lamination process or an extrusion lamination process.

A polymer layer 120 is attached to the inner paper layer 118. The polymer layer 120 defines an interior facing surface 124 of the structure 110. The polymer layer 120 may be a monolayer film structure or a multiplayer film structure. The polymer layer 120 may be a barrier film structure comprising a gas barrier layer or a non-barrier film structure, depending on the desired application. In certain embodiments, the structure 110 includes an optional second bonding layer 118 for joining the polymer layer 120 to the inner paper layer 116. In embodiments the optional second bonding layer 114 may be an adhesive layer or an extruded resin layer. The polymer layer 120 and inner paper layer 116 may be brought together via an adhesive lamination process or an extrusion lamination process. In alternative embodiments, the optional second bonding layer 118 is omitted and the polymer layer 120 is bonded directly to the inner paper layer 116, e.g., via a coating process, an extrusion coating process, or a coextrusion coating process. Optionally, a moisture barrier layer 165 may be provided on the exterior facing surface of the outer paper layer 112, as will be described in greater detail below.

Referring now to FIGS. 2-7, which show some of the presently preferred embodiments, FIG. 2 is a cross-sectional view of a first embodiment paper web base 210. The paper base web 210 comprises an outer paper layer 212. The outer paper layer 212 has an exterior facing surface 222 of the paper base web 210 when the paper base web 210 is used to form a thermoformed packaging tray. Printed indicia or graphics comprising inks and associated varnishes and lacquers may be provided on the exterior facing surface 222 of the outer paper layer 212.

The outer paper layer 212 is adhesively laminated to a first major surface of an inner paper layer 216 with a first adhesive layer 214. In embodiments, the first adhesive layer 214 is a high viscosity adhesive. A second major surface of the inner paper layer 216, in turn, is adhesively laminated to a polymer layer 220 with a second adhesive layer 218. In embodiments, the second adhesive layer 218 is a high viscosity adhesive. The polymer layer 220 has an interior facing surface 224 which is configured to contact or face a packaged product when the paper base web 210 is used to form a thermoformed packaging tray.

In embodiments, the outer and inner paper layers 212, 216 together comprise at least 80%, e.g., 80% to 99%, e.g., 80%, 81%, 81%, 83%, 84%, 85%, 86%, 87%, 88%, 89% 90%, 91%, 91%, 93%, 94%, 95%, 96%, 97%, 98%, or 99% of the paper base web structure 210 by weight, so that the paper base web structure 210 is recyclable in paper recycling streams.

Each of the outer paper layer 212 and the inner paper layer 216, which may be the same or different, may be any suitable paper type having a basis weight in the range of from about 50 grams per square meter (GSM) to about 300 GSM, e.g., 50 GSM, 60 GSM, 70 GSM, 80 GSM, 90 GSM, 100 GSM, 110 GSM, 120 GSM, 130 GSM, 140 GSM, 150 GSM, 160 GSM, 170 GSM, 180 GSM, 190 GSM, 200 GSM, 210 GSM, 220 GSM, 230 GSM, 240 GSM, 250 GSM, 260 GSM, 270 GSM, 280 GSM, 290 GSM, or 300 GSM. In embodiments, each of the outer paper layer 212 and the inner paper layer 216, which may be the same or different, have a basis weight in the range of from about 100 GSM to about 200 GSM. In embodiments, each of the outer paper layer 212 and the inner paper layer 216, which may be the same or different, have a basis weight of about 150 GSM.

The polymer layer 220, which may be a monolayer structure or a multilayer structure comprises any suitable polymer composition, including homopolymers, copolymers, and polymer blends. In embodiments, the polymer layer 220 comprises a polyolefin polymer. In embodiments, the polymer layer 220 comprises a polyolefin polymer. In embodiments, the polymer layer 220 comprises a polyethylene or polypropylene polymer. In embodiments, the polymer layer 220 comprises a polyethylene polymer. Exemplary polyolefin polymers include, for example, homopolymers, copolymers, and terpolymers of ethylene, high density polyethylene (HDPE), medium density polyethylene (MDPE), linear medium density polyethylene (LMDPE), low density polyethylene (LDPE), linear low density polyethylene (LLDPE), very low density polyethylene (VLDPE), metallocene linear low-density polyethylene (mLLDPE), and homopolymers, copolymers, and terpolymers of polypropylene. Exemplary polyolefin copolymers include ethylene-vinyl acetate copolymer (EVA), ethylene-methyl acrylate copolymer (EMA), ethylene-methyl acrylate-acrylic acid copolymer (EMAA), SURLYN™ or other ionomer resin including ethylene-based ionomer resins and ethylene-methacrylic acid ionomer resins.

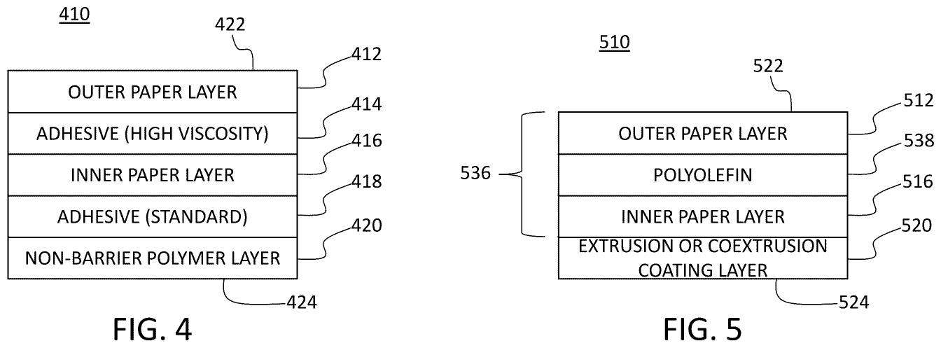

In certain embodiments the polymer layer 220 is a high barrier coextruded layer, an exemplary embodiment of which appears in FIG. 3. In alternative embodiments, the polymer layer 220 is a nonbarrier layer, an exemplary embodiment of which appears in FIG. 4. It will be recognized that multilayer polymer structures 220 may be achieved through a single coextrusion process or through successive extrusion lamination, extrusion coating, or other types of coating operations.

In preferred embodiments, the first adhesive layer 214 comprises a high viscosity adhesive. Unless stated otherwise, all viscosity values herein are at 50° C. (122° F.). In embodiments, the first adhesive layer 214 comprises solvent-free adhesive having a centipoise value of between 300 cP and 500,000 cP, preferably between 1,000 cP and 300,000 cP, and more preferably between 3,000 cP and 200,000 cP. Exemplary high-viscosity adhesives have a viscosity of 300 cP, 1,000 cP, 2,000 cP, 3,000 cP, 4,000 cP, 5,000 cP, 6,000 cP, 7,000 cP, 8,000 cP, 9,000 cP, 10,000 cP, 11,000 cP, 12,000 cP, 13,000 cP, 14,000 cP, 15,000 cP, 16,000 cP, 17,000 cP, 18,000 cP, 19,000 cP, 20,000 cP, 21,000 cP, 22,000 cP, 23,000 cP, 24,000 cP, 25,000 cP, 26,000 cP, 27,000 cP, 28,000 cP, 29,000 cP, 30,000 cP, 31,000 cP, 32,000 cP, 33,000 cP, 34,000 cP, 35,000 cP, 36,000 cP, 37,000 cP, 38,000 cP, 39,000 cP, 40,000 cP, 41,000 cP, 42,000 cP, 43,000 cP, 44,000 cP, 45,000 cP, 46,000 cP, 47,000 cP, 48,000 cP, 49,000 cP, 50,000 cP, 51,000 cP, 52,000 cP, 53,000 cP, 54,000 cP, 55,000 cP, 56,000 cP, 57,000 cP, 58,000 cP, 59,000 cP, 60,000 cP, 61,000 cP, 62,000 cP, 63,000 cP, 64,000 cP, 65,000 cP, 66,000 cP, 67,000 cP, 68,000 cP, 69,000 cP, 70,000 cP, 71,000 cP, 72,000 cP, 73,000 cP, 74,000 cP, 75,000 cP, 76,000 cP, 77,000 cP, 78,000 cP, 79,000 cP, 80,000 cP, 81,000 cP, 82,000 cP, 83,000 cP, 84,000 cP, 85,000 cP, 86,000 cP, 87,000 cP, 88,000 cP, 89,000 cP, 90,000 cP, 91,000 cP, 92,000 cP, 93,000 cP, 94,000 cP, 95,000 cP, 96,000 cP, 97,000 cP, 98,000 cP, 99,000 cP, 100,000 cP, 101,000 cP, 102,000 cP, 103,000 cP, 104,000 cP, 105,000 cP, 106,000 cP, 107,000 cP, 108,000 cP, 109,000 cP, 110,000 cP, 111,000 cP, 112,000 cP, 113,000 cP, 114,000 cP, 115,000 cP, 116,000 cP, 117,000 cP, 118,000 cP, 119,000 cP, 120,000 cP, 121,000 cP, 122,000 cP, 123,000 cP, 124,000 cP, 125,000 cP, 126,000 cP, 127,000 cP, 128,000 cP, 129,000 cP, 130,000 cP, 131,000 cP, 132,000 cP, 133,000 cP, 134,000 cP, 135,000 cP, 136,000 cP, 137,000 cP, 138,000 cP, 139,000 cP, 140,000 cP, 141,000 cP, 142,000 cP, 143,000 cP, 144,000 cP, 145,000 cP, 146,000 cP, 147,000 cP, 148,000 cP, 149,000 cP, 150,000 cP, 151,000 cP, 152,000 cP, 153,000 cP, 154,000 cP, 155,000 cP, 156,000 cP, 157,000 cP, 158,000 cP, 159,000 cP, 160,000 cP, 161,000 cP, 162,000 cP, 163,000 cP, 164,000 cP, 165,000 cP, 166,000 cP, 167,000 cP, 168,000 cP, 169,000 cP, 170,000 cP, 171,000 cP, 172,000 cP, 173,000 cP, 174,000 cP, 175,000 cP, 176,000 cP, 177,000 cP, 178,000 cP, 179,000 cP, 180,000 cP, 181,000 cP, 182,000 cP, 183,000 cP, 184,000 cP, 185,000 cP, 186,000 cP, 187,000 cP, 188,000 cP, 189,000 cP, 190,000 cP, 191,000 cP, 192,000 cP, 193,000 cP, 194,000 cP, 195,000 cP, 196,000 cP, 197,000 cP, 198,000 cP, 199,000 cP, 200,000 cP, 201,000 cP, 202,000 cP, 203,000 cP, 204,000 cP, 205,000 cP, 206,000 cP, 207,000 cP, 208,000 cP, 209,000 cP, 210,000 cP, 211,000 cP, 212,000 cP, 213,000 cP, 214,000 cP, 215,000 cP, 216,000 cP, 217,000 cP, 218,000 cP, 219,000 cP, 220,000 cP, 221,000 cP, 222,000 cP, 223,000 cP, 224,000 cP, 225,000 cP, 226,000 cP, 227,000 cP, 228,000 cP, 229,000 cP, 230,000 cP, 231,000 cP, 232,000 cP, 233,000 cP, 234,000 cP, 235,000 cP, 236,000 cP, 237,000 cP, 238,000 cP, 239,000 cP, 240,000 cP, 241,000 cP, 242,000 cP, 243,000 cP, 244,000 cP, 245,000 cP, 246,000 cP, 247,000 cP, 248,000 cP, 249,000 cP, 250,000 cP, 251,000 cP, 252,000 cP, 253,000 cP, 254,000 cP, 255,000 cP, 256,000 cP, 257,000 cP, 258,000 cP, 259,000 cP, 260,000 cP, 261,000 cP, 262,000 cP, 263,000 cP, 264,000 cP, 265,000 cP, 266,000 cP, 267,000 cP, 268,000 cP, 269,000 cP, 270,000 cP, 271,000 cP, 272,000 cP, 273,000 cP, 274,000 cP, 275,000 cP, 276,000 cP, 277,000 cP, 278,000 cP, 279,000 cP, 280,000 cP, 281,000 cP, 282,000 cP, 283,000 cP, 284,000 cP, 285,000 cP, 286,000 cP, 287,000 cP, 288,000 cP, 289,000 cP, 290,000 cP, 291,000 cP, 292,000 cP, 293,000 cP, 294,000 cP, 295,000 cP, 296,000 cP, 297,000 cP, 298,000 cP, 299,000 cP, 300,000 cP, 301,000 cP, 302,000 cP, 303,000 cP, 304,000 cP, 305,000 cP, 306,000 cP, 307,000 cP, 308,000 cP, 309,000 cP, 310,000 cP, 311,000 cP, 312,000 cP, 313,000 cP, 314,000 cP, 315,000 cP, 316,000 cP, 317,000 cP, 318,000 cP, 319,000 cP, 320,000 cP, 321,000 cP, 322,000 cP, 323,000 cP, 324,000 cP, 325,000 cP, 326,000 cP, 327,000 cP, 328,000 cP, 329,000 cP, 330,000 cP, 331,000 cP, 332,000 cP, 333,000 cP, 334,000 cP, 335,000 cP, 336,000 cP, 337,000 cP, 338,000 cP, 339,000 cP, 340,000 cP, 341,000 cP, 342,000 cP, 343,000 cP, 344,000 cP, 345,000 cP, 346,000 cP, 347,000 cP, 348,000 cP, 349,000 cP, 350,000 cP, 351,000 cP, 352,000 cP, 353,000 cP, 354,000 cP, 355,000 cP, 356,000 cP, 357,000 cP, 358,000 cP, 359,000 cP, 360,000 cP, 361,000 cP, 362,000 cP, 363,000 cP, 364,000 cP, 365,000 cP, 366,000 cP, 367,000 cP, 368,000 cP, 369,000 cP, 370,000 cP, 371,000 cP, 372,000 cP, 373,000 cP, 374,000 cP, 375,000 cP, 376,000 cP, 377,000 cP, 378,000 cP, 379,000 cP, 380,000 cP, 381,000 cP, 382,000 cP, 383,000 cP, 384,000 cP, 385,000 cP, 386,000 cP, 387,000 cP, 388,000 cP, 389,000 cP, 390,000 cP, 391,000 cP, 392,000 cP, 393,000 cP, 394,000 cP, 395,000 cP, 396,000 cP, 397,000 cP, 398,000 cP, 399,000 cP, 400,000 cP, 401,000 cP, 402,000 cP, 403,000 cP, 404,000 cP, 405,000 cP, 406,000 cP, 407,000 cP, 408,000 cP, 409,000 cP, 410,000 cP, 411,000 cP, 412,000 cP, 413,000 cP, 414,000 cP, 415,000 cP, 416,000 cP, 417,000 cP, 418,000 cP, 419,000 cP, 420,000 cP, 421,000 cP, 422,000 cP, 423,000 cP, 424,000 cP, 425,000 cP, 426,000 cP, 427,000 cP, 428,000 cP, 429,000 cP, 430,000 cP, 431,000 cP, 432,000 cP, 433,000 cP, 434,000 cP, 435,000 cP, 436,000 cP, 437,000 cP, 438,000 cP, 439,000 cP, 440,000 cP, 441,000 cP, 442,000 cP, 443,000 cP, 444,000 cP, 445,000 cP, 446,000 cP, 447,000 cP, 448,000 cP, 449,000 cP, 450,000 cP, 451,000 cP, 452,000 cP, 453,000 cP, 454,000 cP, 455,000 cP, 456,000 cP, 457,000 cP, 458,000 cP, 459,000 cP, 460,000 cP, 461,000 cP, 462,000 cP, 463,000 cP, 464,000 cP, 465,000 cP, 466,000 cP, 467,000 cP, 468,000 cP, 469,000 cP, 470,000 cP, 471,000 cP, 472,000 cP, 473,000 cP, 474,000 cP, 475,000 cP, 476,000 cP, 477,000 cP, 478,000 cP, 479,000 cP, 480,000 cP, 481,000 cP, 482,000 cP, 483,000 cP, 484,000 cP, 485,000 cP, 486,000 cP, 487,000 cP, 488,000 cP, 489,000 cP, 490,000 cP, 491,000 cP, 492,000 cP, 493,000 cP, 494,000 cP, 495,000 cP, 496,000 cP, 497,000 cP, 498,000 cP, 499,000 cP, 500,000 cP, or within any subrange between any of the foregoing viscosity values.

In embodiments, the first adhesive layer 214 comprises a high viscosity adhesive having a solids content of between 15% and 100%, preferably 30% to 100%, and more preferably 100% or close to 100%. In embodiments, the adhesive first adhesive layer 214 comprises a high viscosity adhesive having a solids content in the range of 15-30%. In embodiments, the adhesive first adhesive layer 214 comprises a high viscosity adhesive having a solids content in the range of 30-50%. In embodiments, the adhesive first adhesive layer 214 comprises a high viscosity adhesive having a solids content in the range of 50-60%. In embodiments, the adhesive first adhesive layer 214 comprises a high viscosity adhesive having a solids content in the range of 60-80%. In embodiments, the adhesive first adhesive layer 214 comprises a high viscosity adhesive having a solids content in the range of 70-90%. In embodiments, the adhesive first adhesive layer 214 comprises a high viscosity adhesive having a solids content in the range of 90-100%. All percentages given herein are by weight unless specifically stated otherwise.

Exemplary adhesives suitable for the first adhesive layer 214 include single component adhesives, two component adhesives, solvent-based adhesives, solventless adhesives, water-based adhesives, acrylic adhesives, extruded polyethylene or polypropylene adhesive systems, electron beam curable adhesives, and ultraviolet radiation (UV) curable adhesives, and the like, as would be understood by persons skilled in the art.

It has been found that the use of a high viscosity adhesive as the first adhesive layer 214 allows for a thermoformable, laminated, paper base web structure 210 with a single polymer layer 220, thereby eliminating additional, i.e., inner, polymer layer(s) of the prior art base web structures to provide a recyclable structure while retaining draw forming capabilities, e.g., 1 mm to 153 mm form depth, preferably up to 21 mm form depth, without ripping on the production line.

The second adhesive layer 218 may comprise any suitable lamination adhesive. In embodiments, the second adhesive layer 218 comprises a solvent free adhesive, solvent-based adhesive, or water based adhesive. In embodiments, the second adhesive layer 218 comprises low or medium viscosity adhesive. In embodiments, the second adhesive layer 218 is applied at a coating weight of 0.9 lb to 5 lb per 3000 square foot ream.

Exemplary adhesives suitable for the second adhesive layer 218 include single component adhesives, two component adhesives, solvent-based adhesives, solventless adhesives, water-based adhesives, acrylic adhesives, extruded polyethylene or polypropylene adhesive systems, electron beam lamination adhesives, and UV lamination adhesives, as would be understood by persons skilled in the art.

Now referring to FIG. 3, there is shown an exemplary paper base web embodiment 310, which is generally as shown and described above by way of reference to FIG. 2, wherein the polymer layer 220 comprises a multilayer gas and/or moisture layer 320. The multilayer gas and/or moisture barrier layer 320 is formed via a coextrusion process.

An outer paper layer 312 defines an exterior surface 322 of the paper base web 310 and is laminated to an inner paper layer 316 via an adhesive layer 314 (preferably a high viscosity adhesive). The inner paper layer 316 is laminated to the coextruded layer 320 via an adhesive layer 318 (preferably a low or medium viscosity adhesive).

It is to be understood that in embodiments where adjacent polymer layers may be incompatible, an optional tie layer can be provided, e.g., between a barrier layer and any adjacent layer(s), as would be recognized by a person skilled in the art to promote adhesion and improve interlayer bonding. It is to be further understood that where tie layers are shown in the drawings and/or described herein in detail, such tie layers are provided for illustrative purposes and are considered optional.

The coextruded layer 320 comprises a first polyolefin layer 326 directly adjacent the adhesive layer 318. A first tie layer 328 is adjacent to the first polyolefin layer 326, opposite the adhesive layer. A barrier layer 330 is adjacent to the first tie layer 328 and a second tie layer 332 is adjacent the barrier layer 330 opposite the first tie layer 328. A second polyolefin layer 334 is adjacent the second tie layer 332 and defines an interior-facing surface 324 of the base web 310. In embodiments, the inner and outer paper layers 312, 316 together represent at least 80% by weight of the paper base web structure 310 and less than 100% by weight of the paper base web structure 310 so that the paper base web structure 310 is recyclable in paper recycling streams. In embodiments, the outer and inner paper layers 312, 316 together comprise at least 85% by weight of the thermoformable paper base web 310 and less than 100% by weight of the thermoformable paper base web 310. In embodiments, the outer and inner paper layers 312, 316 together comprise at least 90% by weight of the thermoformable paper base web 310 and less than 100% by weight of the thermoformable paper base web 310. In embodiments, the outer and inner paper layers 312, 316 together comprise at least 95% by weight of the thermoformable paper base web 310 and less than 100% by weight of the thermoformable paper base web 310. In embodiments, the outer and inner paper layers 312, 316 together comprise at least 80% by weight of the thermoformable paper base web 310 and less or equal to 95% by weight of the thermoformable paper base web 310.

In certain embodiments, the first and second polyolefin layers 326, 334 are formed of polyethylene. In certain embodiments, the barrier layer 330 is formed of EVOH (with or without compatibilizer additives). Other polymer barrier layers 330 include polyvinylidene di-chloride (PVcD), polyamides (such as nylons), polyvinyl alcohol (PVOH). Exemplary tie layers 328, 332 include maleic anhydride (MAH) or other tie resin or adhesion promotor as would be known by persons skilled in the art. Although a five-layer multilayer film structure 320 is shown, it will be recognized that other numbers of layers, including seven-layer, nine-layer, and others are also contemplated.

The high barrier properties provided by the coextruded layer 320 allow for forming packages for consumable products. In particular, the base web 310 may advantageously be used to manufacture thermoformed trays for packing chilled cooked meats, while maintaining the required commercial shelf life of the product.

In reducing the embodiment appearing in FIG. 3 to practice, inner and outer paper layers (Billerud FiberForm™, available from Billerud AB, Solna, Sweden), each having a basis weight of 150 GSM, were adhesively laminated using MORCHEM™ XPL 531300 adhesive to form a paper adhesive lamination. A coextruded film comprising having a structure: PE-Tie Layer-EVOH-Tie Layer-PE (available from Vizelpas-Flexible Films, S.A. (Vilarinho, Santo Tirso, Portugal)) having a basis weight of 27.8 GSM was then adhesively laminated to the paper adhesive lamination with MORCHEM™ PL 278-CF 744 adhesive. The resulting base web structure had the properties shown in the table below:

| | Test Method | Value | Tolerance | Unit |
|---|---|---|---|---|
| Basis Weight | Micrometer | 327.8 | ±10% | GSM |
| Oxygen Transmission | ASTM D3895 | ≤2.2 | ±5% | cc/m²/24 hrs |
| Rate (23° C./0% RH) | | | | |
| Water Vapor | ASTM F1249 | ≤8.9 | ±5% | g/m²/24 hrs |
| Transmission Rate | | | | |
| (38° C./90% RH) | | | | |

Now referring to FIG. 4, there appears an alternative base web embodiment 410, which is generally as shown and described above by way of reference to FIG. 2, wherein the polymer layer 220 comprises a nonbarrier polymer layer. The base web 410 is advantageously used for the manufacture of thermoformed trays for products that are not sensitive to oxygen, moisture, or other gas intrusion. An outer paper layer 412 defines an exterior surface 422 of the paper base web 410 and is laminated to an inner paper layer 416 via an adhesive layer 414 (preferably a high viscosity adhesive). The inner paper layer 416 is laminated to the nonbarrier polymer layer 420 via an adhesive layer 418 (preferably a low or medium viscosity adhesive). The nonbarrier polymer layer 420 is a monolayer structure or multilayer structure.

The layer 420 may comprise any suitable polymer composition, including homopolymers, copolymers, and polymer blends. When the nonbarrier polymer layer 420 is a multilayer structure, each layer within the multilayer structure can be the same or different. In certain embodiments, the nonbarrier polymer layer 420 comprises a polyolefin, preferably polyethylene. In embodiments, the inner and outer paper layers 412, 416 together represent at least 80% by weight of the paper base web structure 410 and less than 100% by weight of the paper base web structure 410 so that the paper base web structure 410 is recyclable in paper recycling streams. In embodiments, the outer and inner paper layers 412, 416 together comprise at least 85% by weight of the thermoformable paper base web 410 and less than 100% by weight of the thermoformable paper base web 410. In embodiments, the outer and inner paper layers 412, 416 together comprise at least 90% by weight of the thermoformable paper base web 410 and less than 100% by weight of the thermoformable paper base web 410. In embodiments, the outer and inner paper layers 412, 416 together comprise at least 95% by weight of the thermoformable paper base web 410 and less than 100% by weight of the thermoformable paper base web 410. In embodiments, the outer and inner paper layers 412, 416 together comprise at least 80% by weight of the thermoformable paper base web 410 and less or equal to 95% by weight of the thermoformable paper base web 410.

Now referring to FIG. 5, there is shown a further embodiment paper base web 510 comprising a paper-based extrusion lamination 536 and an extrusion or coextrusion coating layer 520. The paper-based extrusion lamination 536 includes an outer paper layer 512 which is extrusion laminated to an inner paper layer 516 via a polyolefin layer 538. The outer paper layer 522 includes an exterior facing surface 522 which is configured to face away from a product to be packaged when the paper base web 510 is formed into a packaging tray.

The extrusion coating or coextrusion coating layer 520 is disposed on an interior facing surface of the inner paper layer 516. The extrusion coating or coextrusion coating layer 520 has an inner facing surface 522 which is configured to contact or face toward a product to be packaged when the paper base web 510 is formed into a packaging tray. In embodiments, the inner and outer paper layers 512, 516 together represent at least 80% by weight of the paper base web structure 510 and less than 100% by weight of the paper base web structure 510 so that the paper base web structure 510 is recyclable in paper recycling streams. In embodiments, the outer and inner paper layers 512, 516 together comprise at least 85% by weight of the thermoformable paper base web 510 and less than 100% by weight of the thermoformable paper base web 510. In embodiments, the outer and inner paper layers 512, 516 together comprise at least 90% by weight of the thermoformable paper base web 510 and less than 100% by weight of the thermoformable paper base web 510. In embodiments, the outer and inner paper layers 512, 516 together comprise at least 95% by weight of the thermoformable paper base web 510 and less than 100% by weight of the thermoformable paper base web 510. In embodiments, the outer and inner paper layers 512, 516 together comprise at least 80% by weight of the thermoformable paper base web 510 and less or equal to 95% by weight of the thermoformable paper base web 510.

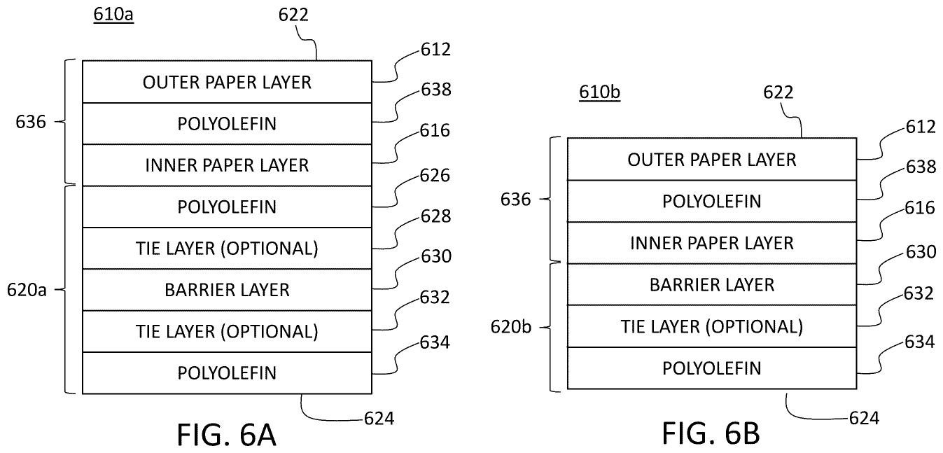

Referring now to FIG. 6A, there is shown a paper base web embodiment 610a, which is generally as shown and described by way of reference to the paper base web embodiment 510 appearing in FIG. 5, wherein the extrusion or coextrusion coating layer 520 of FIG. 5 is a barrier coextrusion coating layer 620a.

The coextrusion coating layer 620a comprises a first polyolefin layer 626 directly adjacent the inner paper layer 616. A first tie layer 628 is adjacent to the first polyolefin layer 626, opposite the inner paper layer 616. A barrier layer 630 is adjacent to the first tie layer 628 and a second tie layer 632 is adjacent the barrier layer 630 opposite the first tie layer 628. A second polyolefin layer 634 is adjacent the second tie layer 632 and defines an interior-facing surface 624 of the base web 610a.

In embodiments, the first and second polyolefin layers 626, 634 are formed of polyethylene. In certain embodiments, the barrier layer 630 is formed of EVOH (with or without compatibilizer additives). Other polymer barrier layers 630 include polyvinylidene di-chloride (PVcD), polyamides (such as nylons), polyvinyl alcohol (PVOH). Exemplary tie layers 628, 632 include maleic anhydride (MAH) or other tie resin or adhesion promotor as would be known by persons skilled in the art. Although a three-resin, five-layer multilayer film structure 620a is shown, it will be recognized that other numbers of layers, including seven-layer, nine-layer, and others are also contemplated. In embodiments, the inner and outer paper layers 612, 616 together represent at least 80% by weight of the paper base web structure 610a and less than 100% of the paper base web structure 610a so that the paper base web structure 610a is recyclable in paper recycling streams. In embodiments, the outer and inner paper layers 612, 616 together comprise at least 85% by weight of the thermoformable paper base web 610a and less than 100% by weight of the thermoformable paper base web 610a. In embodiments, the outer and inner paper layers 612, 616 together comprise at least 90% by weight of the thermoformable paper base web 610a and less than 100% by weight of the thermoformable paper base web 610a. In embodiments, the outer and inner paper layers 612, 616 together comprise at least 95% by weight of the thermoformable paper base web 610a and less than 100% by weight of the thermoformable paper base web 610a. In embodiments, the outer and inner paper layers 612, 616 together comprise at least 80% by weight of the thermoformable paper base web 610a and less or equal to 95% by weight of the thermoformable paper base web 610a.

In reducing the present development to practice, the embodiment appearing in FIG. 6A was produced using an outer paper layer having a basis weight of 150 GSM and an inner paper layer having a basis weight of 100 GSM. The inner and outer paper layers were extrusion laminated with a polyethylene extrusion layer. The polyethylene extrusion layer had a basis weight of 8 GSM. Next, the inner paper layer was surface treated with flame and corona and a 5 layer coextrusion coating comprising PE-Tie Resin-EVOH-Tie Resin-PE was brought on to the treated surface of the inner paper layer 616. The coextrusion coating had a basis weight of 16 GSM.

Referring now to FIG. 6B, there is shown a paper base web embodiment 610b, which is generally as shown and described by way of reference to the paper base web embodiment 610a appearing in FIG. 6A, wherein the extrusion or coextrusion coating layer 620a of FIG. 6A is replaced with a barrier coextrusion coating layer 620b.

The coextrusion coating layer 620b comprises a barrier layer 630 formed of an extrudable barrier polymer material which is directly adjacent the inner paper layer 616. A polyolefin layer 634 is adjacent the barrier layer 630 and defines an interior-facing surface 624 of the base web 610b.

In embodiments, the polyolefin layer 634 is formed of polyethylene. In embodiments, the barrier layer 630 is formed of EVOH (with or without compatibilizer additives). Other polymer barrier layers 630 include polyvinylidene di-chloride (PVcD), polyamides (such as nylons), polyvinyl alcohol (PVOH). In embodiments, the inner and outer paper layers 612, 616 together represent at least 80% by weight of the paper base web structure 610b and less than 100% by weight of the paper base web structure 610b so that the paper base web structure 610b is recyclable in paper recycling streams. In embodiments, the outer and inner paper layers 612, 616 together comprise at least 85% by weight of the thermoformable paper base web 610b and less than 100% by weight of the thermoformable paper base web 610b. In embodiments, the outer and inner paper layers 612, 616 together comprise at least 90% by weight of the thermoformable paper base web 610b and less than 100% by weight of the thermoformable paper base web 610b. In embodiments, the outer and inner paper layers 612, 616 together comprise at least 95% by weight of the thermoformable paper base web 610b and less than 100% by weight of the thermoformable paper base web 610b. In embodiments, the outer and inner paper layers 612, 616 together comprise at least 80% by weight of the thermoformable paper base web 610b and less or equal to 95% by weight of the thermoformable paper base web 610b.

In embodiments, the paper base web 610b appearing in FIG. 6B is produced using an outer paper layer having a basis weight of 150 GSM and an inner paper layer having a basis weight of 100 GSM. The inner and outer paper layers are extrusion laminated with a polyethylene extrusion layer. The polyethylene extrusion layer has a basis weight of 8 GSM. Next, the inner paper layer is surface treated with flame and corona and a 2 layer coextrusion coating comprising EVOH-PE is brought onto the treated surface of the inner paper layer 616.

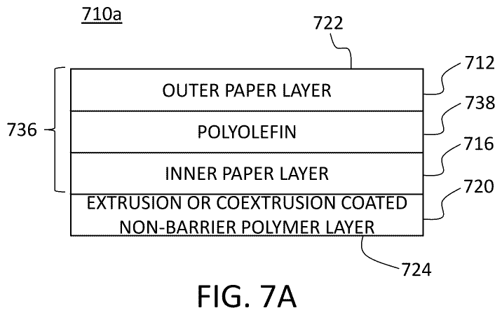

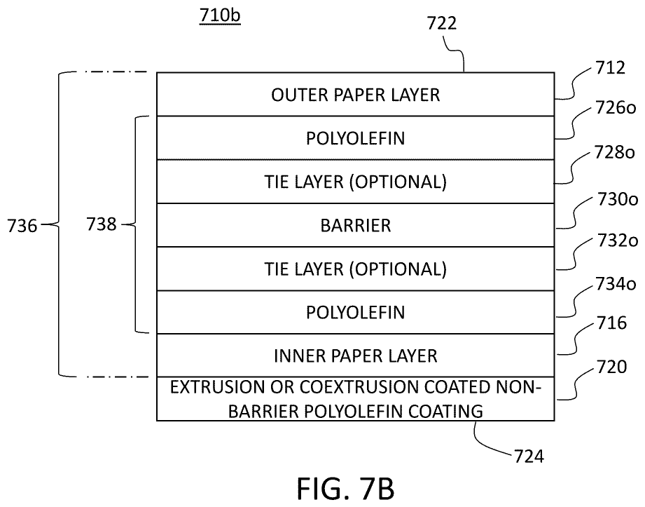

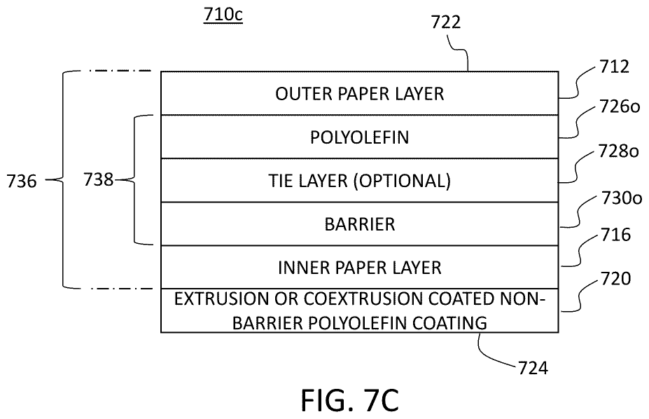

Now referring to FIG. 7A, there appears a paper base web embodiment 710a, which is generally as shown and described by way of reference to the paper base web embodiment 510 appearing in FIG. 5, wherein the extrusion or coextrusion coating layer 520 of FIG. 5 is a nonbarrier extrusion coating or coextrusion layer 720. The base web 710a is advantageously used for the manufacture of thermoformed trays for products that are not sensitive to oxygen, moisture, or other gas intrusion.

A paper based extrusion lamination 736 comprises an outer paper layer 712, which defines an exterior surface 722 of the paper base web 710a, and which is extrusion laminated to an inner paper layer 716 via a polyolefin layer 738. In certain embodiments, the polyolefin layer 738 is polyethylene. The extrusion lamination 736, in turn, is extrusion coated or coextrusion coated with a nonbarrier polymer layer 720.

In certain embodiments, the nonbarrier polymer layer 720 is a single layer, extruded coating layer. In certain embodiments, the nonbarrier polymer layer 720 is a multilayer, coextruded coating layer. The extrusion coated or coextrusion coated nonbarrier polymer layer 720 may comprise any suitable polymer composition, including homopolymers, copolymers, and polymer blends. When the nonbarrier polymer layer 720 is a multilayer coextrusion coating, each layer within the multilayer structure can be the same or different. In certain embodiments, the nonbarrier polymer layer 720 comprises a polyolefin, preferably polyethylene. In embodiments, the inner and outer paper layers 712, 716 together represent at least 80% by weight of the paper base web structure 710a and less than 100% by weight of the paper base web structure 710a so that the paper base web structure 710a is recyclable in paper recycling streams. In embodiments, the outer and inner paper layers 712, 716 together comprise at least 85% by weight of the thermoformable paper base web 710a and less than 100% by weight of the thermoformable paper base web 710a. In embodiments, the outer and inner paper layers 712, 716 together comprise at least 90% by weight of the thermoformable paper base web 710a and less than 100% by weight of the thermoformable paper base web 710a. In embodiments, the outer and inner paper layers 712, 716 together comprise at least 95% by weight of the thermoformable paper base web 710a and less than 100% by weight of the thermoformable paper base web 710a. In embodiments, the outer and inner paper layers 712, 716 together comprise at least 80% by weight of the thermoformable paper base web 710a and less or equal to 95% by weight of the thermoformable paper base web 710a.

Now referring to FIG. 7B, there appears a paper base web embodiment 710b, which is generally as shown and described by way of reference to the paper base web embodiment 710a appearing in FIG. 7A, wherein the polyolefin layer 738 is a barrier coextrusion layer which bonds the outer paper layer 712 to the inner paper layer 716. The base web 710b is advantageously used for the manufacture of thermoformed trays for products that are sensitive to oxygen, moisture, or other gas intrusion.

The base web 710b includes a paper based extrusion lamination 736 which comprises the outer paper layer 712, which defines an exterior surface 722 of the paper base web 710b, and which is extrusion laminated to the inner paper layer 716 via the polyolefin barrier coextrusion layer 738. The extrusion lamination 736, in turn, is extrusion coated or coextrusion coated with a nonbarrier polymer layer 720.

The polymer layer 738 comprises a core barrier layer 7300 disposed intermediate an outer polyolefin layer 7260 and an inner polyolefin layer 7340. Optionally, a first tie layer 7280 is disposed intermediate the outer polyolefin layer 7260 and the core barrier layer 7300 and an optional second tie layer 7320 is disposed intermediate the inner polyolefin layer 7340 and the core barrier layer 7300 to enhance adhesion and compatibility between the layers. The outer polyolefin layer 7260 is positioned on the exterior side of the barrier layer 7300 to protect the barrier layer 7300 from mechanical stress, punctures, etc. during handling.

In certain embodiments, the nonbarrier polymer layer 720 is a single layer, extruded coating layer. In certain embodiments, the nonbarrier polymer layer 720 is a multilayer, coextruded coating layer. The extrusion coated or coextrusion coated nonbarrier polymer layer 720 may comprise any suitable polymer composition, including homopolymers, copolymers, and polymer blends. When the nonbarrier polymer layer 720 is a multilayer coextrusion coating, each layer within the multilayer structure can be the same or different. In certain embodiments, the nonbarrier polymer layer 720 comprises a polyolefin, preferably polyethylene. In embodiments, the inner and outer paper layers 712, 716 together represent at least 80% by weight of the paper base web structure 710b and less than 100% by weight of the paper base web structure 710b so that the paper base web structure 710b is recyclable in paper recycling streams. In embodiments, the outer and inner paper layers 712, 716 together comprise at least 85% by weight of the thermoformable paper base web 710b and less than 100% by weight of the thermoformable paper base web 710b. In embodiments, the outer and inner paper layers 712, 716 together comprise at least 90% by weight of the thermoformable paper base web 710b and less than 100% by weight of the thermoformable paper base web 710b. In embodiments, the outer and inner paper layers 712, 716 together comprise at least 95% by weight of the thermoformable paper base web 710b and less than 100% by weight of the thermoformable paper base web 710b. In embodiments, the outer and inner paper layers 712, 716 together comprise at least 80% by weight of the thermoformable paper base web 710b and less or equal to 95% by weight of the thermoformable paper base web 710b.

Now referring to FIG. 7C, there appears a paper base web embodiment 710c, which is generally as shown and described by way of reference to the paper base web embodiment 710b appearing in FIG. 7B, except that the inner polyolefin layer 7340 and optional second tie layer 7320 of the polymer layer 738 are omitted. The outer polyolefin layer 7260 is positioned on the exterior side of the barrier layer 7300 to protect the barrier layer 7300 from mechanical stress, punctures, etc. during handling. In addition, omitting the inner polyolefin layer 7340 and optional second tie layer 7320 from the polymer layer 738 decreases the overall polymer content in the base web 710c, thus increasing the relative proportion of paper content in the base web 710c and enhancing recyclability within paper recycling streams. In embodiments, the inner and outer paper layers 712, 716 together represent at least 80% by weight of the paper base web structure 710c and less than 100% by weight of the paper base web structure 710c so that the paper base web structure 710c is recyclable in paper recycling streams. In embodiments, the outer and inner paper layers 712, 716 together comprise at least 85% by weight of the thermoformable paper base web 710c and less than 100% by weight of the thermoformable paper base web 710c. In embodiments, the outer and inner paper layers 712, 716 together comprise at least 90% by weight of the thermoformable paper base web 710c and less than 100% by weight of the thermoformable paper base web 710c. In embodiments, the outer and inner paper layers 712, 716 together comprise at least 95% by weight of the thermoformable paper base web 710c and less than 100% by weight of the thermoformable paper base web 710c. In embodiments, the outer and inner paper layers 712, 716 together comprise at least 80% by weight of the thermoformable paper base web 710c and less or equal to 95% by weight of the thermoformable paper base web 710c.

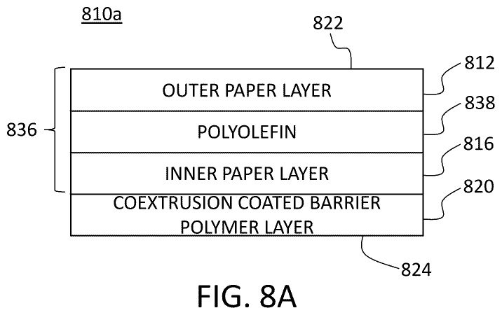

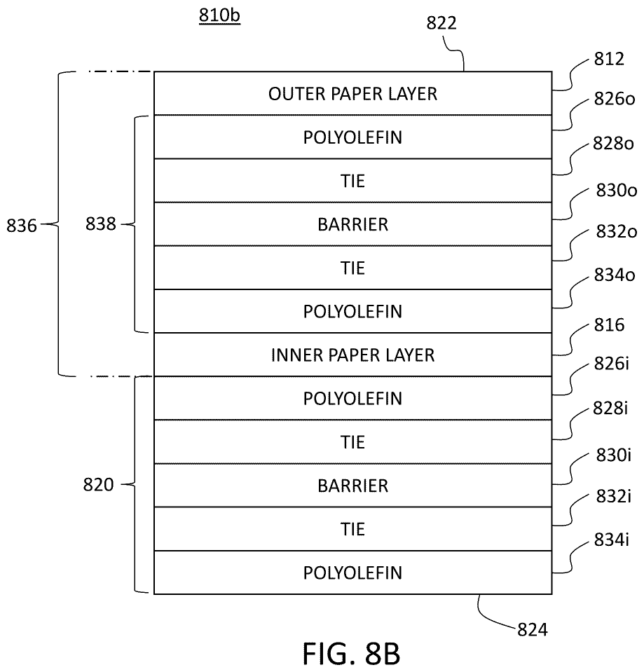

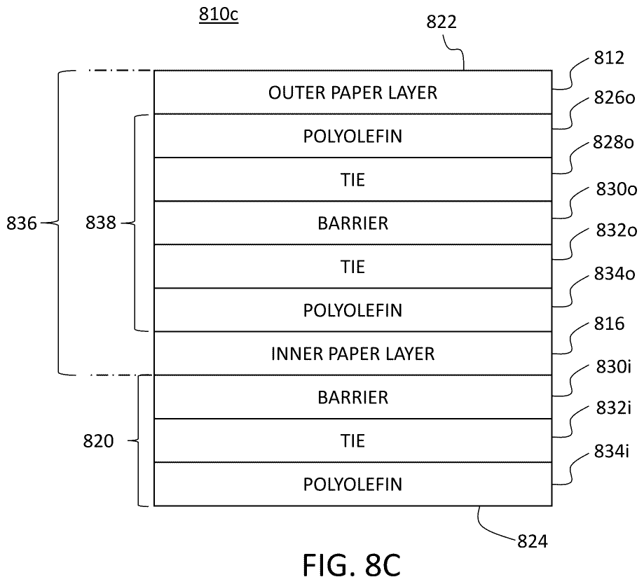

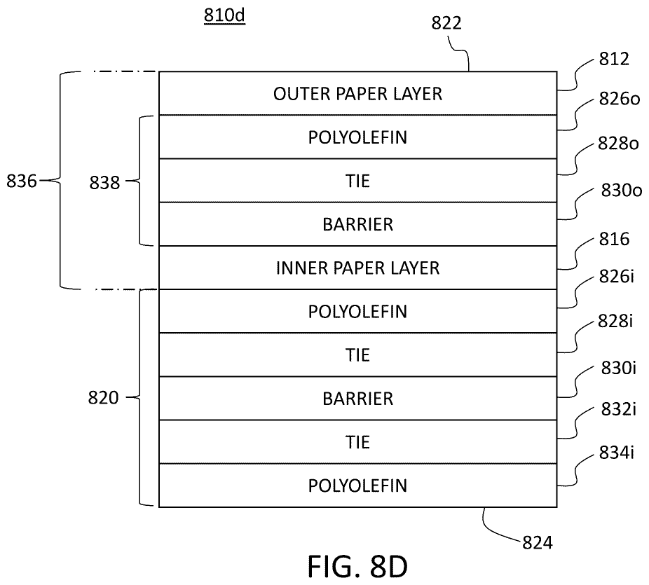

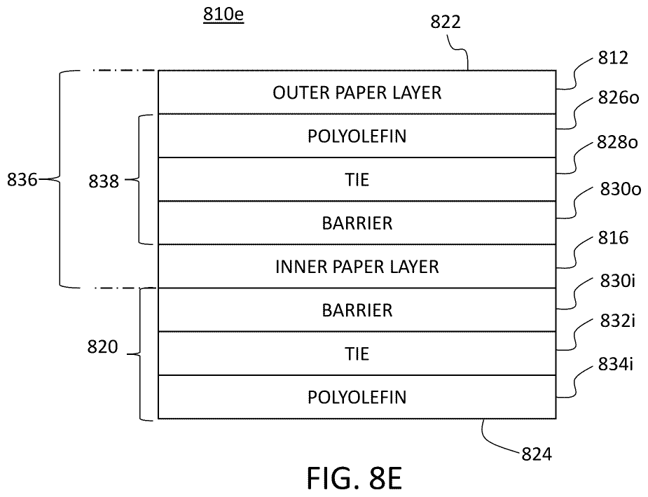

Now referring to FIG. 8A, there appears a paper base web embodiment 810a, which is generally as shown and described by way of reference to the paper base web embodiment 710a appearing in FIG. 7A except that the polymer layer 720 is a coextrusion coated barrier layer 820. The base web 810a is advantageously used for the manufacture of thermoformed trays for products that are sensitive to oxygen, moisture, or other gas intrusion. In embodiments, the inner and outer paper layers 812, 816 together represent at least 80% by weight of the paper base web structure 810a and less than 100% by weight of the paper base web structure 810a so that the paper base web structure 810a is recyclable in paper recycling streams. In embodiments, the outer and inner paper layers 812, 816 together comprise at least 85% by weight of the thermoformable paper base web 810a and less than 100% by weight of the thermoformable paper base web 810a. In embodiments, the outer and inner paper layers 812, 816 together comprise at least 90% by weight of the thermoformable paper base web 810a and less than 100% by weight of the thermoformable paper base web 810a. In embodiments, the outer and inner paper layers 812, 816 together comprise at least 95% by weight of the thermoformable paper base web 810a and less than 100% by weight of the thermoformable paper base web 810a. In embodiments, the outer and inner paper layers 812, 816 together comprise at least 80% by weight of the thermoformable paper base web 810a and less or equal to 95% by weight of the thermoformable paper base web 810a.

Now referring to FIG. 8B, there appears a paper base web embodiment 810b, which is generally as shown and described by way of reference to the paper base web embodiment 810a appearing in FIG. 8A, wherein the polyolefin layer 838 is a barrier coextrusion layer which bonds the outer paper layer 812 to the inner paper layer 816. The base web 810b is advantageously used for the manufacture of thermoformed trays for products that are sensitive to oxygen, moisture, or other gas intrusion.

The base web 810b includes a paper based extrusion lamination 836 which comprises the outer paper layer 812, which defines an exterior surface 822 of the paper base web 810b, and which is extrusion laminated to the inner paper layer 816 via the polyolefin barrier coextrusion layer 838. The extrusion lamination 836, in turn, is extrusion coated or coextrusion coated with a barrier polymer layer 820, as described below.

The polymer layer 838 comprises a core barrier layer 8300 disposed intermediate an outer polyolefin layer 8260 and an inner polyolefin layer 8340. Optionally, a first tie layer 8280 is disposed intermediate the outer polyolefin layer 8260 and the core barrier layer 8300 and an optional second tie layer 8320 is disposed intermediate the inner polyolefin layer 8340 and the core barrier layer 8300 to enhance adhesion and compatibility between the layers. The outer polyolefin layer 8260 is positioned on the exterior side of the barrier layer 8300 to protect the barrier layer 8300 from mechanical stress, punctures, etc. during handling.

The polymer layer 820 comprises a core barrier layer 830i disposed intermediate an outer polyolefin layer 826i and an inner polyolefin layer 834i. Optionally, a first tie layer 828i is disposed intermediate the outer polyolefin layer 826i and the core barrier layer 830i and an optional second tie layer 832i is disposed intermediate the inner polyolefin layer 834i and the core barrier layer 830i to enhance adhesion and compatibility between the layers. In certain embodiments, the polyolefin layers 8260, 8340, 826i, and 834i comprise polyethylene. In certain embodiments, the barrier layers 8300 and 830i comprise EVOH.

In embodiments, the inner and outer paper layers 812, 816 together represent at least 80% by weight of the paper base web structure 810b and less than 100% by weight of the paper base web structure 810b so that the paper base web structure 810b is recyclable in paper recycling streams. In embodiments, the outer and inner paper layers 812, 816 together comprise at least 85% by weight of the thermoformable paper base web 810b and less than 100% by weight of the thermoformable paper base web 810b. In embodiments, the outer and inner paper layers 812, 816 together comprise at least 90% by weight of the thermoformable paper base web 810b and less than 100% by weight of the thermoformable paper base web 810b. In embodiments, the outer and inner paper layers 812, 816 together comprise at least 95% by weight of the thermoformable paper base web 810b and less than 100% by weight of the thermoformable paper base web 810b. In embodiments, the outer and inner paper layers 812, 816 together comprise at least 80% by weight of the thermoformable paper base web 810b and less or equal to 95% by weight of the thermoformable paper base web 810b.

Now referring to FIG. 8C, there appears a paper base web embodiment 810c, which is generally as shown and described by way of reference to the paper base web embodiment 810b appearing in FIG. 8B, except that the outer polyolefin layer 826i and optional first tie layer 828i of the polymer layer 820 are omitted. Omitting the outer polyolefin layer 826i and optional first tie layer 828i from the polymer layer 820 decreases the overall polymer content in the base web 810c, thus increasing the relative proportion of paper content in the base web 810c and enhancing recyclability within paper recycling streams. In embodiments, the inner and outer paper layers 812, 816 together represent at least 80% by weight of the paper base web structure 810c and less than 100% by weight of the paper base web structure 810c so that the paper base web structure 810c is recyclable in paper recycling streams. In embodiments, the outer and inner paper layers 812, 816 together comprise at least 85% by weight of the thermoformable paper base web 810c and less than 100% by weight of the thermoformable paper base web 810c. In embodiments, the outer and inner paper layers 812, 816 together comprise at least 90% by weight of the thermoformable paper base web 810c and less than 100% by weight of the thermoformable paper base web 810c. In embodiments, the outer and inner paper layers 812, 816 together comprise at least 95% by weight of the thermoformable paper base web 810c and less than 100% by weight of the thermoformable paper base web 810c. In embodiments, the outer and inner paper layers 812, 816 together comprise at least 80% by weight of the thermoformable paper base web 810c and less or equal to 95% by weight of the thermoformable paper base web 810c.

Now referring to FIG. 8D, there appears a paper base web embodiment 810d, which is generally as shown and described by way of reference to the paper base web embodiment 810b appearing in FIG. 8B, except that the inner polyolefin layer 8340 and optional second tie layer 8320 of the polymer layer 838 are omitted. The outer polyolefin layer 8260 is positioned on the exterior side of the barrier layer 8300 to protect the barrier layer 8300 from mechanical stress, punctures, etc. during handling. In addition, omitting the inner polyolefin layer 8340 and optional second tie layer 8320 from the polymer layer 838 decreases the overall polymer content in the base web 810d, thus increasing the relative proportion of paper content in the base web 810d and enhancing recyclability within paper recycling streams. In embodiments, the inner and outer paper layers 812, 816 together represent at least 80% by weight of the paper base web structure 810d and less than 100% by weight of the paper base web structure 810d so that the paper base web structure 810d is recyclable in paper recycling streams. In embodiments, the outer and inner paper layers 812, 816 together comprise at least 85% by weight of the thermoformable paper base web 810d and less than 100% by weight of the thermoformable paper base web 810d. In embodiments, the outer and inner paper layers 812, 816 together comprise at least 90% by weight of the thermoformable paper base web 810d and less than 100% by weight of the thermoformable paper base web 810d. In embodiments, the outer and inner paper layers 812, 816 together comprise at least 95% by weight of the thermoformable paper base web 810d and less than 100% by weight of the thermoformable paper base web 810d. In embodiments, the outer and inner paper layers 812, 816 together comprise at least 80% by weight of the thermoformable paper base web 810d and less or equal to 95% by weight of the thermoformable paper base web 810d.

Now referring to FIG. 8E, there appears a paper base web embodiment 810e, which is generally as shown and described by way of reference to the paper base web embodiment 810b appearing in FIG. 8B, except that the outer polyolefin layer 826i and optional first tie layer 828i of the polymer layer 820 are omitted and the inner polyolefin layer 8340 and optional second tie layer 8320 of the polymer layer 838 are omitted. The outer polyolefin layer 8260 is positioned on the exterior side of the barrier layer 8300 to protect the barrier layer 8300 from mechanical stress, punctures, etc. during handling. In addition, omitting the outer polyolefin layer 826i and optional first tie layer 828i of the polymer layer 820 and the inner polyolefin layer 8340 and optional second tie layer 8320 of the polymer layer 838 decreases the overall polymer content in the base web 810e, thus increasing the relative proportion of paper content in the base web 810e and enhancing recyclability within paper recycling streams. In embodiments, the inner and outer paper layers 812, 816 together represent at least 80% by weight of the paper base web structure 810e and less than 100% by weight of the paper base web structure 810e so that the paper base web structure 810e is recyclable in paper recycling streams. In embodiments, the outer and inner paper layers 812, 816 together comprise at least 85% by weight of the thermoformable paper base web 810e and less than 100% by weight of the thermoformable paper base web 810e. In embodiments, the outer and inner paper layers 812, 816 together comprise at least 90% by weight of the thermoformable paper base web 810e and less than 100% by weight of the thermoformable paper base web 810e. In embodiments, the outer and inner paper layers 812, 816 together comprise at least 95% by weight of the thermoformable paper base web 810e and less than 100% by weight of the thermoformable paper base web 810e. In embodiments, the outer and inner paper layers 812, 816 together comprise at least 80% by weight of the thermoformable paper base web 810e and less or equal to 95% by weight of the thermoformable paper base web 810e.

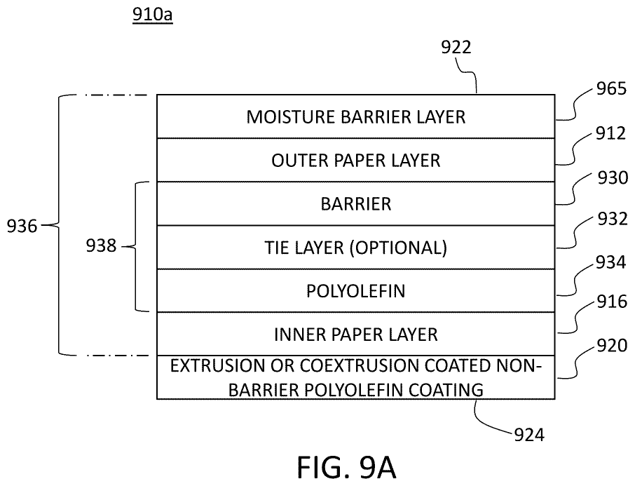

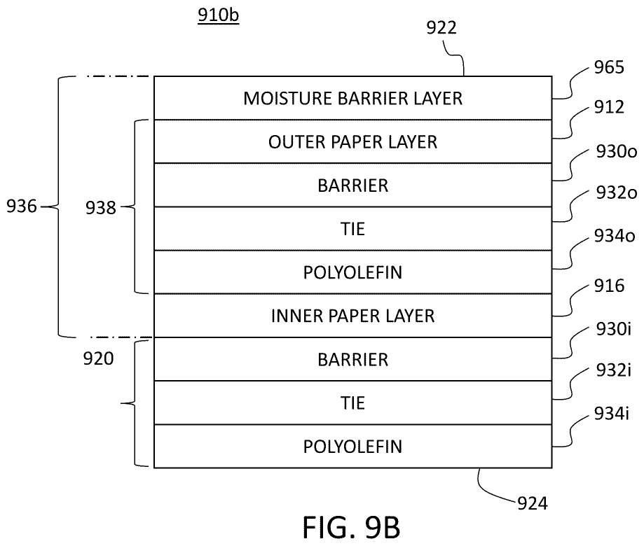

The paper base web structures in accordance with this disclosure may optionally include a moisture barrier layer disposed on the exterior-facing surface of the outer paper layer to enhance moisture resistance, especially in embodiments where the paper base web includes a moisture-sensitive gas/oxygen barrier layer, such as EVOH, PVOH, nylon, or the like. The optional moisture barrier layer serves to protect the gas/oxygen barrier properties of the barrier layer from degradation due to exposure to external moisture or humidity. The optional exterior moisture barrier layer is particularly advantageous, for example, when the gas barrier layer is attached directly to the inner paper layer or outer paper layer and there is no moisture barrier layer in the base web structure disposed exterior to the barrier layer to protect the gas/oxygen barrier from moisture and humidity. FIGS. 9A and 9B illustrate some illustrative embodiments of paper base web structures in accordance with this disclosure employing an exterior moisture barrier layer. It will be recognized, however, that the moisture barrier layer may also be employed with any of the paper base web structures disclosed herein, including the structures shown in FIGS. 1-5, 6A, 6B, 7A-7C, 8A-8D, and others, to achieve improved moisture resistance as desired.

Referring now to FIG. 9A, there appears a paper base web embodiment 910a, which is generally as shown and described by way of reference to the paper base web embodiment 710b appearing in FIG. 7B, wherein the polyolefin layer 7260 and optional tie layer 7280 have been omitted so that a barrier layer 930 is attached directly to the outer paper layer 912. The polyolefin layer 938 is thus a barrier coextrusion layer which bonds the outer paper layer 912 to the inner paper layer 916. The base web 910a is advantageously used for the manufacture of thermoformed trays for products that are sensitive to oxygen, moisture, or other gas intrusion.

The base web 910a includes a paper based extrusion lamination 936 which comprises the outer paper layer 912, which defines an exterior surface 922 of the paper base web 910a, and which is extrusion laminated to the inner paper layer 916 via the polyolefin barrier coextrusion layer 938. The extrusion lamination 936, in turn, is extrusion coated or coextrusion coated with a nonbarrier polymer layer 920.

The polymer layer 938 comprises the barrier layer 930 disposed intermediate the outer paper layer 912 and an inner polyolefin layer 934. Optionally, a tie layer 928 is disposed intermediate the polyolefin layer 926 and the barrier layer 930 to enhance adhesion and compatibility between the layers. The polyolefin layer 934 is positioned on the interior side of the barrier layer 930. To protect the barrier layer 930 from external moisture and humidity which will degrade is gas barrier properties, a moisture barrier layer 965 is disposed on the exterior side of the outer paper layer 912.

In embodiments, the moisture barrier layer 965 comprises a monolayer or multilayer structure comprises any suitable polymer composition with moisture resistance, including homopolymers, copolymers, and polymer blends. In embodiments, the moisture barrier layer 965 comprises a polyolefin polymer. In embodiments, the moisture barrier layer 965 comprises a polyolefin polymer. In embodiments, the moisture barrier layer 965 comprises a polyethylene or polypropylene polymer. In embodiments, the moisture barrier layer 965 comprises a polyethylene polymer. Exemplary polyolefin polymers include, for example, homopolymers, copolymers, and terpolymers of ethylene, high density polyethylene (HDPE), medium density polyethylene (MDPE), linear medium density polyethylene (LMDPE), low density polyethylene (LDPE), linear low density polyethylene (LLDPE), very low density polyethylene (VLDPE), metallocene linear low-density polyethylene (mLLDPE), and homopolymers, copolymers, and terpolymers of polypropylene. Exemplary polyolefin copolymers include ethylene-vinyl acetate copolymer (EVA), ethylene-methyl acrylate copolymer (EMA), ethylene-methyl acrylate-acrylic acid copolymer (EMAA), SURLYN™ or other ionomer resin including ethylene-based ionomer resins and ethylene-methacrylic acid ionomer resins.

In embodiments, the moisture barrier layer 965 comprises a dried polymer dispersion, wherein the moisture barrier layer is applied as a coating in the form of an aqueous or non-aqueous solvent-based polymer dispersion and then dried. Exemplary solvents include water, ethanol, and isopropanol. Exemplary polymers include polyacrylates, latex, waxes (e.g., animal waxes, vegetable waxes, mineral waxes, and petroleum waxes), polystryenes, and polyolefins (e.g., polyethylenes and polypropylenes). The aqueous or non-aqueous solvent-based polymer dispersion is applied by a suitable coating technique, such as roll coating, roll-to-roll coating, various types of gravure coating, flexographic coating, bar coating, doctor blade coating, comma coating, spraying, or brush coating. The solvent is removed using heat, vacuum, forced hot air, drying oven, or the like.

In certain embodiments, the nonbarrier polymer layer 920 is a single layer, extruded coating layer. In certain embodiments, the nonbarrier polymer layer 920 is a multilayer, coextruded coating layer. The extrusion coated or coextrusion coated nonbarrier polymer layer 920 may comprise any suitable polymer composition, including homopolymers, copolymers, and polymer blends. When the nonbarrier polymer layer 920 is a multilayer coextrusion coating, each layer within the multilayer structure can be the same or different. In certain embodiments, the nonbarrier polymer layer 920 comprises a polyolefin, preferably polyethylene. In embodiments, the inner and outer paper layers 912, 916 together represent at least 80% by weight of the paper base web structure 910a and less than 100% by weight of the paper base web structure 910a so that the paper base web structure 910a is recyclable in paper recycling streams. In embodiments, the outer and inner paper layers 912, 916 together comprise at least 85% by weight of the thermoformable paper base web 910a and less than 100% by weight of the thermoformable paper base web 910a. In embodiments, the outer and inner paper layers 912, 916 together comprise at least 90% by weight of the thermoformable paper base web 910a and less than 100% by weight of the thermoformable paper base web 910a. In embodiments, the outer and inner paper layers 912, 916 together comprise at least 95% by weight of the thermoformable paper base web 910a and less than 100% by weight of the thermoformable paper base web 910a. In embodiments, the outer and inner paper layers 912, 916 together comprise at least 80% by weight of the thermoformable paper base web 910a and less or equal to 95% by weight of the thermoformable paper base web 910a.

Referring now to FIG. 9B, there appears a paper base web embodiment 910b, which is generally as shown and described by way of reference to the paper base web embodiment 810b appearing in FIG. 8B, except that the outer polyolefin layer 8260 and the optional first tie layer 8280 are omitted. The paper base web 910b includes a polyolefin layer 938 which is a barrier coextrusion layer that bonds the outer paper layer 912 to the inner paper layer 916. The base web 910b is advantageously used for the manufacture of thermoformed trays for products that are sensitive to oxygen, moisture, or other gas intrusion.

The base web 910b includes a paper based extrusion lamination 936 which comprises the outer paper layer 912, which defines an exterior surface 922 of the paper base web 910b, and which is extrusion laminated to the inner paper layer 916 via the polyolefin barrier coextrusion layer 938. The extrusion lamination 936, in turn, is coextrusion coated with a barrier polymer layer 920, as described below.

The polymer layer 938 comprises a barrier layer 9300 disposed intermediate the outer paper layer 912 and an inner polyolefin layer 9340. Optionally, a tie layer 9320 is disposed intermediate the inner polyolefin layer 9340 and the barrier layer 9300 to enhance adhesion and compatibility between the layers. The inner polyolefin layer 9340 is positioned on the interior side of the barrier layer 9300. To protect the barrier layer 9300 from external moisture and humidity which will degrade is gas barrier properties, a moisture barrier layer 965 is disposed on the exterior side of the outer paper layer 912. The moisture barrier layer 965 may be as described above by way of reference to FIG. 9A.

The polymer layer 920 comprises a core barrier layer 930i disposed intermediate the inner paper layer 916 and an inner polyolefin layer 934i. Optionally, a tie layer 932i is disposed intermediate the inner polyolefin layer 934i and the barrier layer 930i to enhance adhesion and compatibility between the layers. In certain embodiments, the polyolefin layers 9340 and 934i comprise polyethylene. In certain embodiments, the barrier layers 9300 and 930i comprise EVOH.

In embodiments, the inner and outer paper layers 912, 916 together represent at least 80% by weight of the paper base web structure 910b and less than 100% by weight of the paper base web structure 910b so that the paper base web structure 910b is recyclable in paper recycling streams. In embodiments, the outer and inner paper layers 912, 916 together comprise at least 85% by weight of the thermoformable paper base web 910b and less than 100% by weight of the thermoformable paper base web 910b. In embodiments, the outer and inner paper layers 912, 916 together comprise at least 90% by weight of the thermoformable paper base web 910b and less than 100% by weight of the thermoformable paper base web 910b. In embodiments, the outer and inner paper layers 912, 916 together comprise at least 95% by weight of the thermoformable paper base web 910b and less than 100% by weight of the thermoformable paper base web 910b. In embodiments, the outer and inner paper layers 912, 916 together comprise at least 80% by weight of the thermoformable paper base web 910b and less or equal to 95% by weight of the thermoformable paper base web 910b.

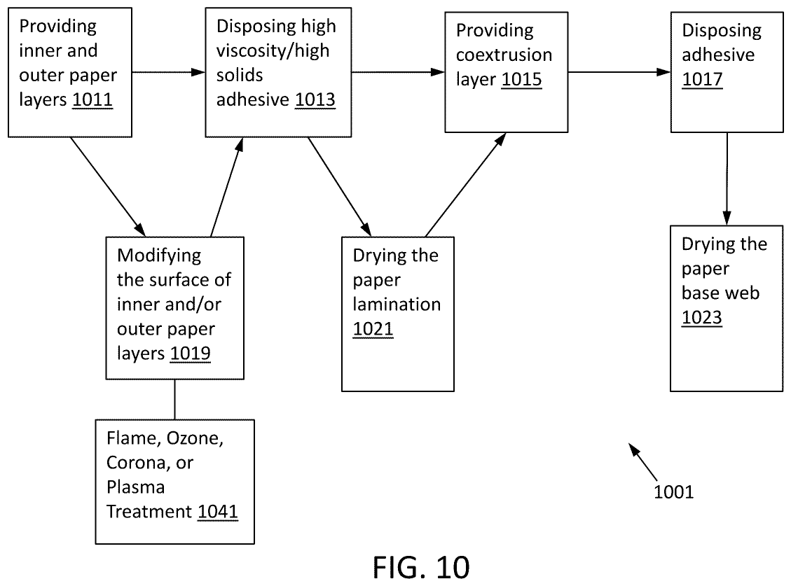

Now referring to FIG. 10, a flow chart illustrating the steps of an exemplary method 1001 for producing an adhesion lamination embodiment paper base web structure as shown in FIGS. 2-4 is provided. Along the top are the steps of method 1001 in its most basic form: providing inner and outer paper layers (step 1011); disposing high a first adhesive layer (e.g., comprising a high viscosity and/or high solids content adhesive) between the inner and outer paper layers and laminating the inner and outer paper layers to form a paper adhesive lamination (step 1013); providing a polymer layer, which may be a single layer or multilayer nonbarrier film or a coextruded barrier film layer (step 1015) and disposing a second adhesive layer between the paper lamination and the polymer layer and laminating the paper lamination and the polymer layer (step 1017) to form a paper base web. In embodiments, the resultant paper base web structure is at least 100% paper by weight based on the weight of the paper base web structure.

In certain embodiments, between providing the inner and outer paper layers at step 1011 and disposing a high viscosity adhesive between the inner and outer paper layers to form a paper lamination at step 1013, a step 1019 of modifying the surfaces of the inner and/or outer paper layers occurs at a step 1041. This surface modification may be, non-exclusively, through flame, ozone, corona, or plasma treatment. In embodiments, surfaces of both of the inner and outer paper layers, between which the first adhesive is disposed, are so treated.

In certain embodiments, between the steps of disposing the first adhesive between the outer and inner paper layers to form a paper lamination at step 1013 and providing the polymer layer at step 1015, a step 1021 of drying the paper lamination occurs. In certain embodiments, after the step of disposing the second adhesive between the paper lamination and the polymer layer at step 1017, a step 1023 of drying the resultant laminated paper base web structure occurs.

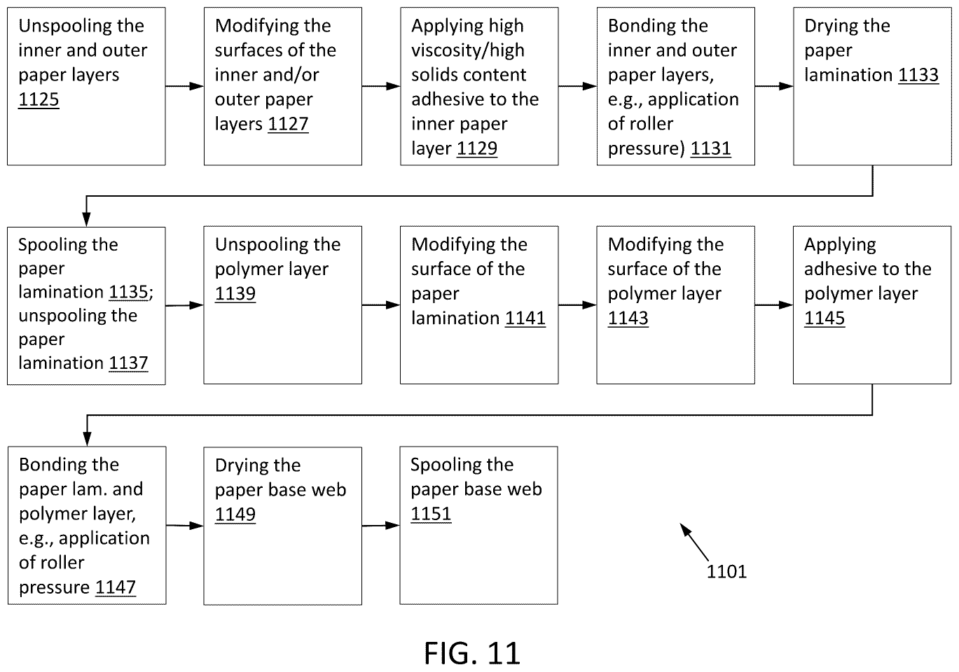

Now referring to FIG. 11, a more detailed flow chart illustrating the steps of a method 1101 in accordance with a preferred embodiment is provided. The method 1101 includes a step 1125 of unspooling the inner and outer paper layers. Optionally, one or both of the surfaces of the inner and outer paper layers to be bonded is surface treated to improve adhesion at step 1127. At step 1129, a first adhesive, e.g., a high viscosity and/or high solids content adhesive, is applied to the inner paper layer.

In the context of adhesively laminating two webs, it should be understood that the descriptions and examples provided herein are not limited to specific configurations of adhesive application. While certain embodiments may depict adhesive being coated onto a specific web and subsequently bonded to another, this disclosure is intended to encompass a broad spectrum of adhesive application methods. For example, where it is specified that an adhesive is applied to the inner paper web and that the inner web is subsequently bonded to the outer paper web, it will be recognized that this disclosure is additionally intended to encompass application of the adhesive to the outer paper web for subsequent bonding to the inner paper web. Likewise, where it is specified that an adhesive is applied to the polymer web and that the polymer web is subsequently bonded to the paper lamination, it will be recognized that this disclosure is additionally intended to encompass application of the adhesive to the paper lamination for subsequent bonding to the polymer web. Moreover, variations are also contemplated wherein adhesive is applied to both of the facing surfaces of the webs to be laminated to achieve adhesion. Still further variations are contemplated where the order of performing the lamination is varied. For example, where it is disclosed that the inner and outer paper webs are adhesively laminated to form a paper lamination and then the paper lamination is subsequently adhesively laminated to the polymer layer to form the base web, it is also contemplated and this disclosure is intended to encompass variations wherein the inner paper web and the polymer web are first adhesively laminated to form a paper/polymer lamination and then the paper/polymer lamination is subsequently adhesively laminated to the outer paper layer to form the base web. This flexibility in adhesive application is applicable to the examples and embodiments provided throughout this document, allowing for the adaptation of methods and techniques to suit specific requirements and preferences in adhesively laminating the paper and polymer webs.

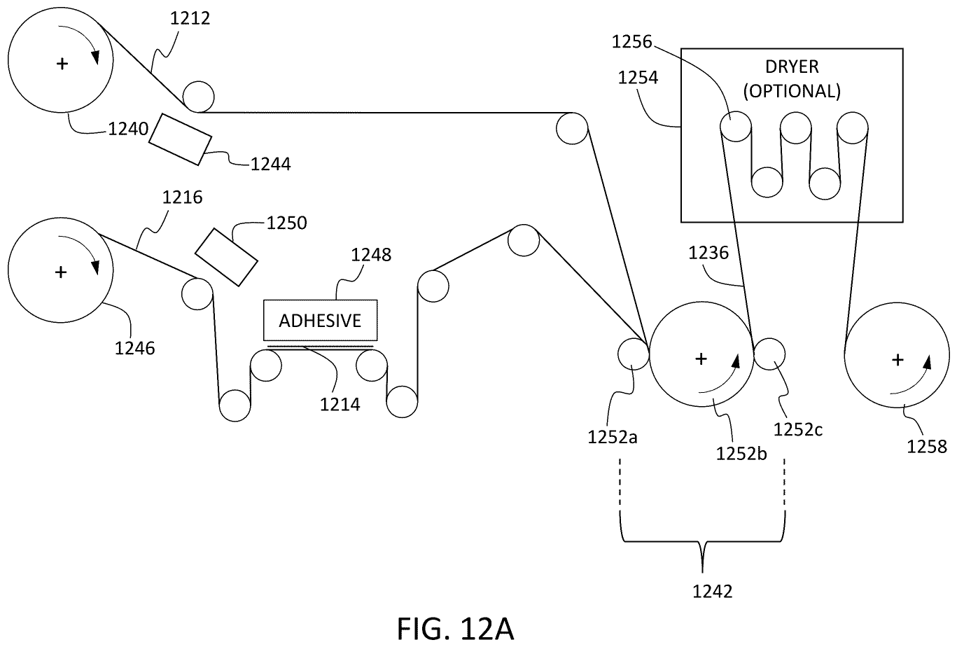

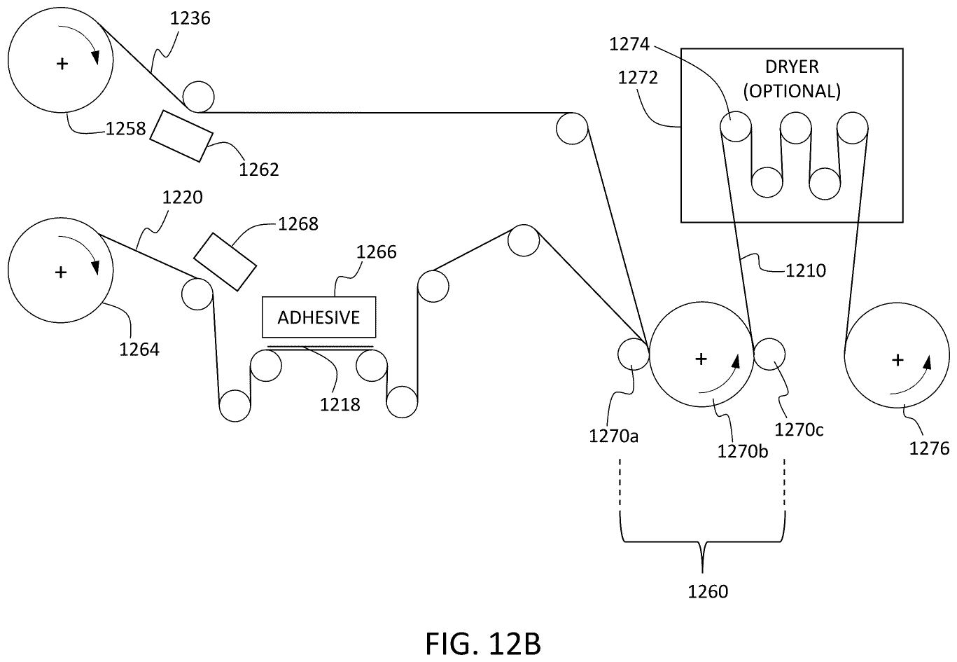

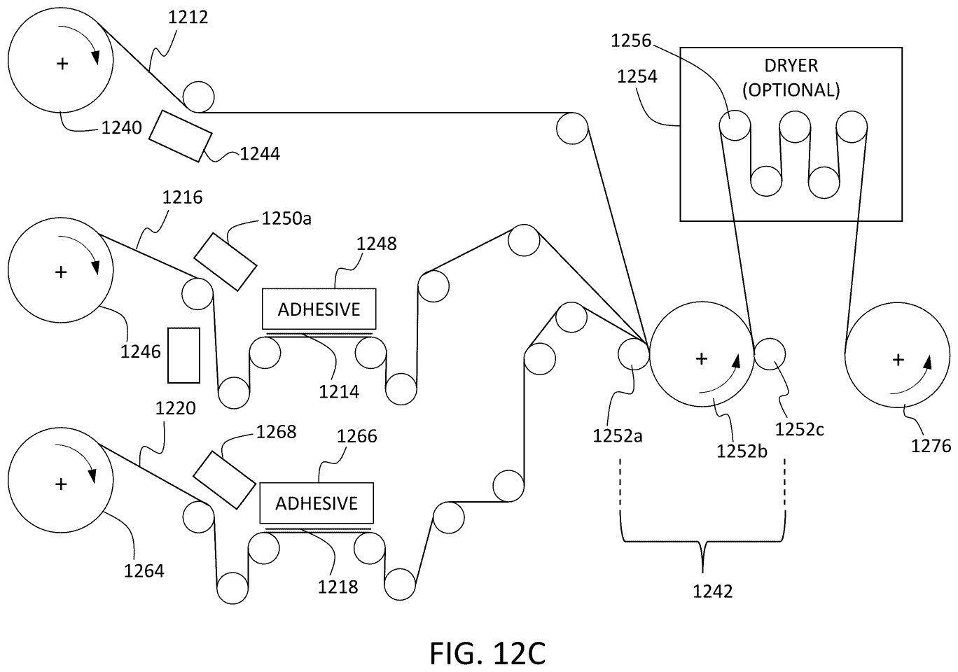

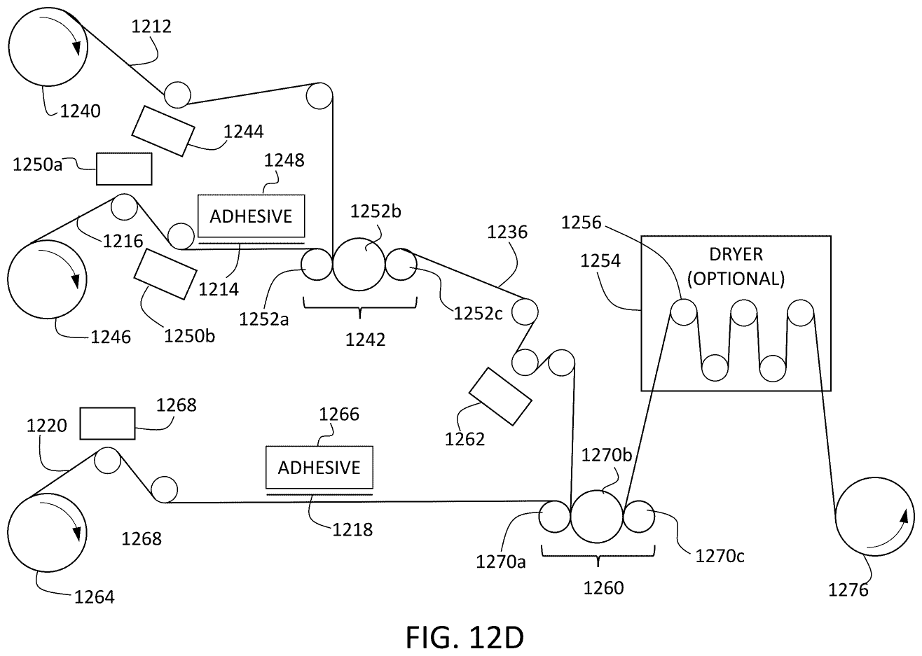

With continued reference to FIG. 11, at a step 1131, the paper layers are bonded to form a resultant paper lamination, e.g., by the application of roller pressure. Optionally, the paper lamination is dried at step 1133. At step 1135, the paper lamination is spooled on a roll for subsequent processing. At step 1137, the paper lamination is unspooled. At step 1139 the polymer layer (i.e., barrier or nonbarrier) is unspooled. At steps 1141 and 1143, the surfaces of the paper lamination and/or the polymer layer, respectively, are optionally modified to promote adhesion, e.g., via flame, corona, ozone, or plasma treatment. A second adhesive is applied to the polymer layer at step 1145. The paper lamination and polymer layer are bonded, e.g., through application of roller pressure at step 1147. Optionally, the resultant paper base web structure is dried at step 1149 and wound up on a finished product roll at step 1151. These steps may be performed in a single process. Alternatively, the steps may be performed in two processes where, the first process ends after the step of drying the paper lamination 212 with an additional step of spooling the paper lamination 222. The second process begins with unspooling the paper lamination 224. Variations on these processes are further illustrated with respect to FIGS. 12A-12D.

The step 1125 of unspooling the outer and inner paper layers is a preferred execution of the step of providing outer and inner paper layers. The step 1129 of applying the high viscosity and/or high solids content adhesive to the outer paper layer is a preferred execution of the step of disposing high viscosity and/or high solids content adhesive between the outer and inner paper layers to form a paper lamination. The step 1139 of unspooling the polymer layer is a preferred execution of the step of providing a polymer layer. The step 1145 of applying the adhesive to the polymer layer is a preferred execution of the step of disposing the second adhesive between the paper lamination and the polymer layer.

Referring now to FIG. 12A, there is shown an exemplary process line suitable for performing a first step of a two-step process for forming the base web structures appearing in FIGS. 2-4. An outer paper layer 1212 is unrolled from a feed roll 1240 and fed toward an adhesive lamination station 1242. Optionally, on the way to the adhesive lamination station 1242, the outer paper layer 1212 is fed past a surface treater 1244, such as a flame treater, corona treater, plasma treater, or ozone treater that treats the surface of the paper layer 1212 to improve adhesion.

An inner paper layer 1216 is unrolled from a feed roll 1246 and fed toward an adhesive coating station 1248. Optionally, on the way to the adhesive coating station 1248, the inner paper layer 1216 is fed past a surface treater 1250. At the adhesive coating station 1248, an adhesive coating 1214 is applied to the facing surface of the inner paper layer 1216. In embodiments, the adhesive coating station 1248 comprises a roll coater, spray coater, slot-die coater, gravure coater, flexographic coater, or the like. The coated paper layer 1216 then continues to the adhesive lamination station 1242.

At the adhesive lamination station 1242, the outer paper layer 1212 and the adhesive coated inner paper layer 1216 come together and pass through a series of rollers, e.g., 1252a, 1252b, 1252c, that apply pressure to bond the outer paper layer 1212 and the inner paper layer 1216 together for forming a paper adhesive lamination 1236. In embodiments, the rollers 1252a, 1252b, 1252c are heated to activate the adhesive and ensure a strong bond. Optionally, the paper adhesive lamination 1236 passes through a dryer 1254, which may include a plurality of rollers 1256 and may include heating elements, fans, and so forth. The paper adhesive lamination 1236 is then wound onto a wind up roll 1258.

Referring now to FIG. 12B, there is shown an exemplary process line suitable for performing a second step of a two-step process for forming the base web structures appearing in FIGS. 2-4. The paper lamination 1236 is unrolled from the roll 1258 and fed toward an adhesive lamination station 1260. Optionally, on the way to the adhesive lamination station 1260, the paper lamination 1236 is fed past a surface treater 1262, such as a flame treater, corona treater, plasma treater, or ozone treater that treats the surface of the paper lamination 1236 to improve adhesion.

A polymer layer 1220, which may be a barrier or nonbarrier polymer layer as described above, is unrolled from a feed roll 1264 and fed toward an adhesive coating station 1266. Optionally, on the way to the adhesive coating station 1266, the polymer layer 1220 is fed past a surface treater 1268. At the adhesive coating station 1266, an adhesive coating 1218 is applied to the facing surface of the polymer layer 1220. In embodiments, the adhesive coating station 1266 comprises a roll coater, spray coater, slot-die coater, gravure coater, flexographic coater, or the like. The coated paper layer polymer layer 1220 then continues to the adhesive lamination station 1260.

At the adhesive lamination station 1260, the adhesive coated polymer layer 1220 and the paper lamination 1236 come together and pass through a series of rollers, e.g., 1270a, 1270b, 1270c, that apply pressure to bond the paper lamination 1236 and the polymer layer 1220 together for forming a base web 1210. In embodiments, the rollers 1270a, 1270b, 1270c are heated to activate the adhesive and ensure a strong bond. Optionally, the base web 1210 passes through a dryer 1272, which may include a plurality of rollers 1274 and may include heating elements, fans, and so forth. The paper web base 1210 is then wound onto a finished product up roll 1276.

Referring now to FIG. 12C, there is shown an exemplary process line suitable for performing a one-step process for forming the base web structures appearing in FIGS. 2-4. An outer paper layer 1212 is unrolled from a feed roll 1240 and fed toward an adhesive lamination station 1242. Optionally, on the way to the adhesive lamination station 1242, the outer paper layer 1212 is fed past a surface treater 1244, such as a flame treater, corona treater, plasma treater, or ozone treater that treats the surface of the paper layer 1212 to improve adhesion.

An inner paper layer 1216 is unrolled from a feed roll 1246 and fed toward an adhesive coating station 1248. Optionally, on the way to the adhesive coating station 1248, the inner paper layer 1216 is fed past a surface treater 1250a and/or 1250b. At the adhesive coating station 1248, an adhesive coating 1214 is applied to the facing surface of the inner paper layer 1216. In embodiments, the adhesive coating station 1248 comprises a roll coater, spray coater, slot-die coater, gravure coater, flexographic coater, or the like. The coated paper layer 1216 then continues to the adhesive lamination station 1242.

A polymer layer 1220, which may be a barrier or nonbarrier polymer layer as described above, is unrolled from a feed roll 1264 and fed toward an adhesive coating station 1266. Optionally, on the way to the adhesive coating station 1266, the polymer layer 1220 is fed past a surface treater 1268. At the adhesive coating station 1266, an adhesive coating 1218 is applied to the facing surface of the polymer layer 1220. In embodiments, the adhesive coating station 1266 comprises a roll coater, spray coater, slot-die coater, gravure coater, flexographic coater, or the like. The coated paper layer polymer layer 1220 then continues to the adhesive lamination station 1260.

At the adhesive lamination station 1242, the outer paper layer 1212, the adhesive coated inner paper layer 1216, and the adhesive coated polymer layer 1220 come together and pass through a series of rollers, e.g., 1252a, 1252b, 1252c, that apply pressure to bond the outer paper layer 1212, the inner paper layer 1216, and polymer layer 1220 together for forming the web base structure 1210. In embodiments, the rollers 1252a, 1252b, 1252c are heated to activate the adhesive and ensure a strong bond. Optionally, the web base structure 1210 passes through a dryer 1254, which may include a plurality of rollers 1256 and may include heating elements, fans, and so forth. The web base structure 1210 is then wound onto a finished product wind up roll 1276.

Referring now to FIG. 12D, there is shown an alternative exemplary process line suitable for performing a one-step process for forming the base web structures appearing in FIGS. 2-4. An outer paper layer 1212 is unrolled from a feed roll 1240 and fed toward an adhesive lamination station 1242. Optionally, on the way to the adhesive lamination station 1242, the outer paper layer 1212 is fed past a surface treater 1244, such as a flame treater, corona treater, plasma treater, or ozone treater that treats the surface of the paper layer 1212 to improve adhesion.

An inner paper layer 1216 is unrolled from a feed roll 1246 and fed toward an adhesive coating station 1248. Optionally, on the way to the adhesive coating station 1248, the inner paper layer 1216 is fed past a surface treater 1250a and/or 1250b. At the adhesive coating station 1248, an adhesive coating 1214 is applied to the facing surface of the inner paper layer 1216. In embodiments, the adhesive coating station 1248 comprises a roll coater, spray coater, slot-die coater, gravure coater, flexographic coater, or the like. The coated paper layer 1216 then continues to the adhesive lamination station 1242.

At the adhesive lamination station 1242, the outer paper layer 1212 and the adhesive coated inner paper layer 1216 come together and pass through a series of rollers, e.g., 1252a, 1252b, 1252c, that apply pressure to bond the outer paper layer 1212 and the inner paper layer 1216 together for forming a paper adhesive lamination 1236. In embodiments, the rollers 1252a, 1252b, 1252c are heated to activate the adhesive and ensure a strong bond. The paper lamination 1236 is fed toward a second adhesive lamination station 1260. Optionally, on the way to the adhesive lamination station 1260, the paper lamination 1236 is fed past a surface treater 1262, such as a flame treater, corona treater, plasma treater, or ozone treater that treats the surface of the paper lamination 1236 to improve adhesion.

A polymer layer 1220, which may be a barrier or nonbarrier polymer layer as described above, is unrolled from a feed roll 1264 and fed toward an adhesive coating station 1266. Optionally, on the way to the adhesive coating station 1266, the polymer layer 1220 is fed past a surface treater 1268. At the adhesive coating station 1266, an adhesive coating 1218 is applied to the facing surface of the polymer layer 1220. In embodiments, the adhesive coating station 1266 comprises a roll coater, spray coater, slot-die coater, gravure coater, flexographic coater, or the like. The coated paper layer polymer layer 1220 then continues to the adhesive lamination station 1260.

At the adhesive lamination station 1260, the adhesive coated polymer layer 1220 and the paper lamination 1236 come together and pass through a series of rollers, e.g., 1270a, 1270b, 1270c, that apply pressure to bond the paper lamination 1236 and the polymer layer 1220 together for forming a base web 1210. In embodiments, the rollers 1270a, 1270b, 1270c are heated to activate the adhesive and ensure a strong bond. Optionally, the base web 1210 passes through a dryer 1272, which may include a plurality of rollers 1274 and may include heating elements, fans, and so forth. The paper web base 1210 is then wound onto a finished product up roll 1276.

It will be recognized that the process lines appearing in FIGS. 12A-12D are exemplary only and that the order of performing the adhesive lamination step and/or which of the facing surfaces to which the adhesive is applied can be modified.

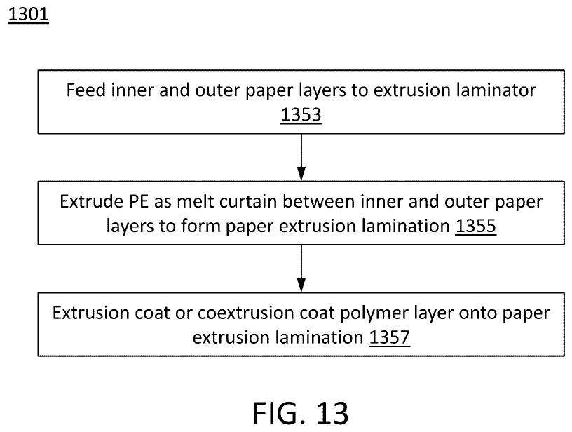

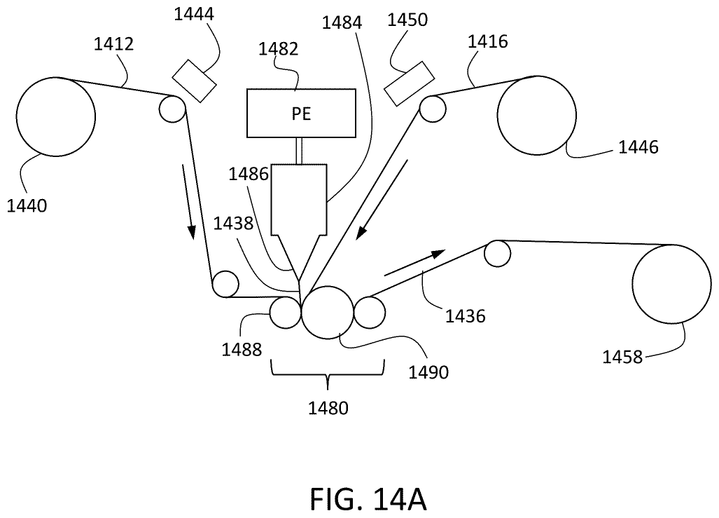

Now referring to FIG. 13, a flow chart illustrating the steps of an exemplary method 1301 for producing an extrusion embodiment paper base web structure as illustrated in FIGS. 5-7. The method 1301 include of feeding inner and outer paper layers to an extrusion lamination station at step 1353. At step 1355, as the inner and outer paper layers converge, molten polyolefin is extruded to form a continuous melt curtain between the inner and outer paper layers to form a paper extrusion lamination. After lamination, the combined paper layers with the molten polyolefin layer may pass through a cooling station where cool air, one or more chill rollers, or other cooling mechanisms are applied to solidify the molten polyolefin. At step 1357, the paper extrusion lamination is fed to an extrusion coating station or coextrusion coating station, as the case may be.

In the case of a monolayer extrusion coating, the polymer layer is applied as an extrusion coating onto the surface of the inner paper layer to form the base web. The base web may be passed to a cooling station for cooling and solidification.

In the case of a multilayer coextrusion coating, multiple materials, e.g., polyolefin, a barrier resin, tie resins, etc., are extruded simultaneously onto the surface of the inner paper layer. The base web may be passed to a cooling station for cooling and solidification.

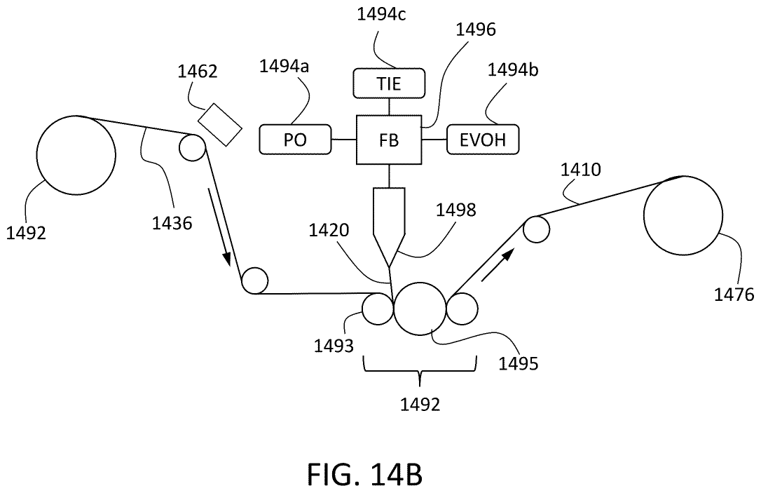

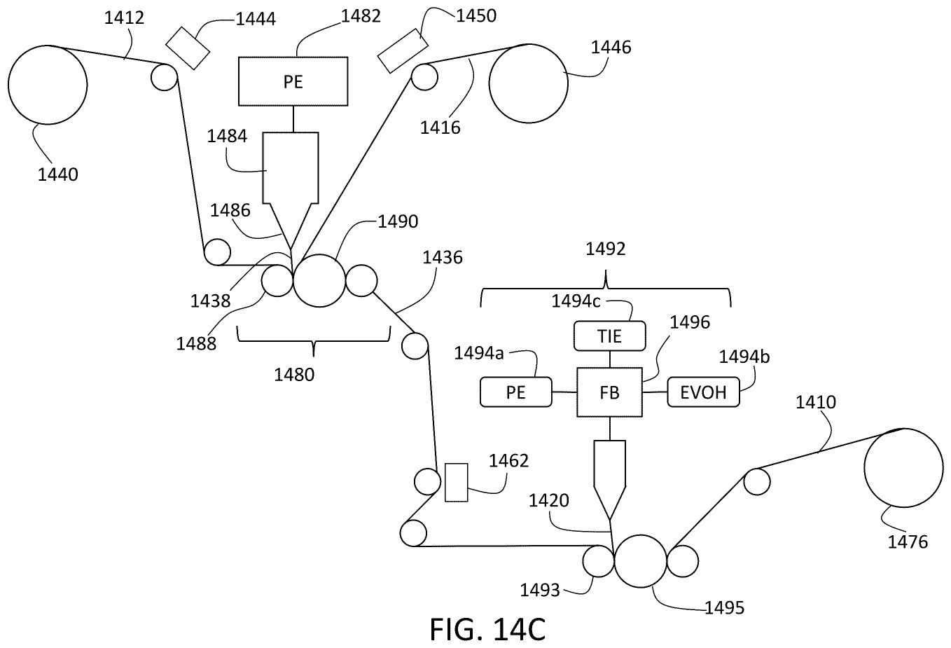

Now referring to FIG. 14A, there is shown an exemplary process line suitable for performing a first step of a two-step process for forming the base web structures appearing in FIGS. 5-7. An outer paper layer 1412 is unrolled from a feed roll 1440 and fed toward an extrusion lamination station 1480. Optionally, on the way to the extrusion lamination station 1480, the outer paper layer 1412 is fed past a surface treater 1444, such as a flame treater, corona treater, plasma treater, or ozone treater that treats the surface of the paper layer 1412 to improve adhesion.

The inner paper layer 1412 is unrolled from a feed roll 1446 and fed toward the extrusion lamination station 1480. Optionally, on the way to the extrusion lamination station 1480, the inner paper layer 1416 is fed past a surface treater 1450, such as a flame treater, corona treater, plasma treater, or ozone treater that treats the surface of the paper layer 1412 to improve adhesion.

The extrusion lamination station 1480 includes a hopper 1482 containing polyolefin, e.g., polyolefin pellets. The hopper 1482 feed the polyolefin into the barrel of an extruder 1484, which includes heating elements and means for conveying the polyolefin resin through the extruder barrel. Molten polyolefin exits a die 1486 as a uniform curtain of molten polyolefin 1438 at a point just before the paper webs 1412, 1416 come together at the nip between a pressure roller 1488 and a chill roller 1490. The resultant paper extrusion lamination 1436 is rolled up onto a take up roll 1458.

Now referring to FIG. 14B, there is shown an exemplary process line suitable for performing a second step of a two-step process for forming the base web structures appearing in FIGS. 5-7. The paper extrusion lamination 1436 is unrolled from the feed roll 1458 and fed toward a coextrusion coating station 1492. Optionally, on the way to the extrusion coating station 1492, the paper extrusion lamination 1436 is fed past a surface treater 1462, such as a flame treater, corona treater, plasma treater, or ozone treater that treats the surface of the paper extrusion lamination 1436 to improve adhesion.

The extrusion coating station 1492 includes hoppers 1494a, 1494b, and 1494c, etc., containing the resins to be coextruded, e.g., polyolefin, EVOH, and tie resin in the depicted embodiment. It will be recognized that other coextrusion structures and compositions are contemplated. The hoppers 1494a-1494c feed the resins into the barrels of respective extruders (not shown). The molten materials from the extruders are combined in a feed block 1496 which arranges the molten resins in the desired layered arrangement and are directed to a coextrusion die 1498. The molten resins exit the die 1498 as a uniform, layered melt curtain at a point just before the lamination 1436 enters the nip between a pressure roller 1493 and a chill roller 1495. The resultant paper web base 1410 is rolled up onto a take up roll 1476.

Referring now to FIG. 14C, there is shown an exemplary process line suitable for performing a one-step process for forming the base web structures appearing in FIGS. 5-7. The outer paper layer 1412 is unrolled from a feed roll 1440 and fed toward an extrusion lamination station 1480. Optionally, on the way to the extrusion lamination station 1480, the outer paper layer 1412 is fed past a surface treater 1444, such as a flame treater, corona treater, plasma treater, or ozone treater that treats the surface of the paper layer 1412 to improve adhesion.

The inner paper layer 1412 is unrolled from a feed roll 1446 and fed toward the extrusion lamination station 1480. Optionally, on the way to the extrusion lamination station 1480, the inner paper layer 1416 is fed past a surface treater 1450, such as a flame treater, corona treater, plasma treater, or ozone treater that treats the surface of the paper layer 1412 to improve adhesion.

The extrusion lamination station 1480 includes a hopper 1482 containing polyolefin, e.g., polyolefin pellets. The hopper 1482 feed the polyolefin into the barrel of an extruder 1484, which includes heating elements and means for conveying the polyolefin resin through the extruder barrel. Molten polyolefin exits a die 1486 as a uniform curtain of molten polyolefin 1438 at a point just before the paper webs 1412, 1416 come together at the nip between a pressure roller 1488 and a chill roller 1490.

The resultant paper extrusion lamination 1436 is fed toward a coextrusion coating station 1492. Optionally, on the way to the extrusion coating station 1492, the paper extrusion lamination 1436 is fed past a surface treater 1462, such as a flame treater, corona treater, plasma treater, or ozone treater that treats the surface of the paper extrusion lamination 1436 to improve adhesion.

The extrusion coating station 1492 includes hoppers 1494a, 1494b, and 1494c, etc., containing the resins to be coextruded, e.g., polyolefin, EVOH, and tie resin in the depicted embodiment. It will be recognized that other coextrusion structures and compositions are contemplated. The hoppers 1494a-1494c feed the resins into the barrels of respective extruders (not shown). The molten materials from the extruders are combined in a feed block 1496 which arranges the molten resins in the desired layered arrangement and are directed to a coextrusion die 1498. The molten resins exit the die 1498 as a uniform, layered melt curtain at a point just before the lamination 1436 enters the nip between a pressure roller 1493 and a chill roller 1495. The resultant paper web base 1410 is rolled up onto a take up roll 1476.

The process line embodiments appearing in FIGS. 14A-14C illustrate a preferred embodiment, wherein the polymer layer 1420 is a coextruded barrier layer. In alternative embodiments, the polymer layer 1420 may be a monolayer, wherein the coextrusion coater 1492 is replaced with an extrusion coater. In embodiments, the polymer layer 1420 may be a nonbarrier layer, an exemplary embodiment of which appears in FIG. 7A. It will be recognized that other multilayer polymer structures 1420 may be achieved through a single coextrusion process or through successive extrusion lamination, extrusion coating, or other types of coating operations.

Particular aspects of the disclosure are described below in the following sets of interrelated Clauses:

Clause 1. A paper base web structure comprising:
an outer paper layer having a paper external surface and a paper internal surface;
a first adhesive layer adjacent to said paper internal surface;
an inner paper layer adjacent to said first adhesive layer;
a second adhesive layer adjacent to said inner paper layer; and
a coextruded film layer having a coextrusion external surface and a coextrusion internal surface, wherein said second adhesive layer is adjacent to said coextrusion internal surface;
wherein said outer and inner paper layers together comprise at least 80% by weight of said paper base web and less than 100% by weight of said paper base web.

Clause 2. The paper base web of Clause 1, wherein said outer and inner paper layers are comprised of thermoformable paper with greater than 5% stretch.

Clause 3. The paper base web of Clause 2, wherein said outer and inner paper layers are comprised of thermoformable paper with between 10% and 30% stretch.

Clause 4. The paper base web of Clause 3, wherein said outer and inner paper layers are comprised of thermoformable paper with between 10% and 20% stretch.

Clause 5. The paper base web of Clause 4, wherein said outer and inner paper layers are comprised of thermoformable paper with 13% stretch.

Clause 6. The paper base web of Clause 1, wherein said first adhesive layer is comprised of a high viscosity adhesive.

Clause 7. The paper base web of Clause 6, wherein said high viscosity adhesive has a centipoise value between 300 cP and 500,000 cP at 50 degrees C.

Clause 8. The paper base web of Clause 7, wherein said high viscosity adhesive has a centipoise value of 2000.

Clause 9. The paper base web of Clause 1, wherein said first adhesive layer has a solids content of between 15% and 100% by weight.

Clause 10. The paper base web of Clause 9, wherein said first adhesive layer has a solids content between 99% and 100% by weight.

Clause 11. The paper base web of Clause 1, wherein said first and second adhesive layers are solvent-free adhesives.

Clause 12. The paper base web of Clause 1, wherein said outer and inner paper layers each has a basis weight between 50 GSM and 300 GSM.

Clause 13. The paper base web of Clause 12, wherein said outer and inner paper layers each has a basis weight of 150 GSM.

Clause 14. The paper base web of Clause 1, wherein said paper base web has a thickness as measured by a micrometer test method of 327.8±10% GSM.

Clause 15. The paper base web of Clause 1, wherein said paper base web has an OTR as measured utilizing the ASTM D3895 test method at standard test conditions of 23° C. and 0% RH of ≤2.2±5% cc/m²/24 hours.

Clause 16. The paper base web of Clause 1, wherein said paper base web has a WVTR as measured utilizing the ASTM F1249 test method at standard test conditions of 38° C. and 90% RH of ≤8.9±5% g/m²/24 hours.

Clause 17. The paper base web of Clause 1, wherein the paper base web is thermoformable to a form depth of between 1 mm and 153 mm.

Clause 18. The paper base web of Clause 17, wherein the paper base web is thermoformable to a form depth of 21 mm or greater.

Clause 19. The paper base web of Clause 1, wherein said coextruded film layer has a thickness of 27.8 GSM.

Clause 20. The paper base web of Clause 1, wherein said coextruded film layer comprises at least:
a first polyolefin layer adjacent to said second adhesive layer;
a first tie layer;
an EVOH barrier layer;
a second tie layer; and
a second polyolefin layer.

Clause 21. The paper base web of Clause 20, wherein said first and second polyolefin layers of said coextruded film layer comprise polyethylene.

Clause 22. A paper base web structure comprising:
an outer paper layer;
an extrusion layer;
an inner paper layer; and
a coextrusion coating layer;
wherein said outer and inner paper layers comprise at least 80% by weight of said paper base web and less than 100% by weight of said paper base web.

Clause 23. The paper base web of Clause 1, wherein said outer and inner paper layers each has a basis weight of 50 GSM to 300 GSM.

Clause 24. The paper base web of Clause 23, wherein:
said outer paper layer has a basis weight of 150 GSM; and
said inner paper layer has a basis weight of 100 GSM.

Clause 25. The paper base web of Clause 22, wherein said coextrusion coating layer has a coating density of 16 GSM.

Clause 26. The paper base web of Clause 22, wherein said extrusion layer has a basis weight of 8 GSM.

Clause 27. The paper base web of Clause 22, wherein said extrusion layer is comprised of polyethylene.

Clause 28. The paper base web of Clause 22, wherein said coextrusion coating layer comprises at least:
a first polyolefin layer adjacent to said second adhesive layer;
a first tie layer;
an EVOH barrier layer;
a second tie layer; and
a second polyolefin layer.

Clause 29. The paper base web of Clause 28, wherein said first and second polyolefin layers of said coextrusion coating layer comprise polyethylene.

Clause 30. A method for producing a paper base web structure, said method comprising the steps of:
providing first and second layers of paper;
disposing a first adhesive selected from the group consisting of a high viscosity adhesive, a solids content adhesive, or both, between the first and second layers of paper to form a paper lamination;
providing a coextrusion layer; and
disposing a second adhesive between the paper lamination and the coextrusion layer;
wherein:
said coextrusion layer comprises a first polyethylene layer, a first tie layer, an EVOH barrier, a second tie layer, and a second polyethylene layer; and
the paper base web formed thereby comprises at least 80% paper by weight.

Clause 31. The method of Clause 30, further comprising the step of modifying a surface of the first layer of paper before said step of disposing the first adhesive.

Clause 32. The method of Clause 30, further comprising the step of modifying a surface of the second layer of paper before said step of disposing the first adhesive.

Clause 33. The method of Clause 31, wherein said step of modifying a surface of the first layer of paper comprises flame treating a surface of the first layer of paper.

Clause 34. The method of Clause 31, wherein said step of modifying a surface of the first layer of paper comprises ozone treating a surface of the first layer of paper.

Clause 35. The method of Clause 31, wherein said step of modifying a surface of the first layer of paper comprises corona treating a surface of the first layer of paper.

Clause 36. The method of Clause 32, wherein said step of modifying a surface of the second layer of paper comprises flame treating a surface of the second layer of paper.

Clause 37. The method of Clause 32, wherein said step of modifying a surface of the second layer of paper comprises ozone treating a surface of the second layer of paper.

Clause 38. The method of Clause 32, wherein said step of modifying a surface of the second layer of paper comprises corona treating a surface of the second layer of paper.

Clause 39. The method of Clause 30, wherein:
said step of providing a first and second layer of paper is unrolling the first and second layer of paper from first and second spools; and
said step of disposing the first adhesive between the first and second layers of paper comprises coating one of a group consisting of the first layer of paper, the second layer of paper, and the first and second layers of paper with the first adhesive; and
said method further comprises, after said step of disposing the first adhesive between the first and second layers of paper, compressing the first and second layers of paper together through a first set of nip rollers.

Clause 40. The method of Clause 30, further comprising the step of drying the outer and inner paper layers after said step of disposing the first adhesive between the first and second layers of paper.

Clause 41. The method of Clause 30, further comprising the step of rolling the paper lamination into a third spool after said step of disposing the first adhesive between the first and second layers of paper.

Clause 42. The method of Clause 30, wherein said step of providing a coextrusion layer comprises unrolling the coextrusion layer from a fourth spool.

Clause 43. The method of Clause 30, wherein said method further comprises the step of modifying a surface of the paper lamination before said step of disposing the second adhesive between the paper lamination and the coextrusion layer.

Clause 44. The method of Clause 30, further comprising the step of modifying a surface of the coextrusion layer before said step of disposing the second adhesive between the paper lamination and the coextrusion layer.

Clause 45. The method of Clause 43, wherein said step of modifying a surface of the paper lamination comprises flame treating a surface of the paper lamination.

Clause 46. The method of Clause 43, wherein said step of modifying a surface of the paper lamination comprises ozone treating a surface of the paper lamination.

Clause 47. The method of Clause 43, wherein said step of modifying a surface of the paper lamination comprises corona treating a surface of the paper lamination.

Clause 48. The method of Clause 44, wherein said step of modifying a surface of the coextrusion layer comprises flame treating a surface of the coextrusion layer.

Clause 49. The method of Clause 44, wherein said step of modifying a surface of the coextrusion layer comprises ozone treating a surface of the coextrusion layer.

Clause 50. The method of Clause 44, wherein said step of modifying a surface of the coextrusion layer comprises corona treating a surface of the coextrusion layer.

Clause 51. The method of Clause 30, wherein:
said step of disposing the second adhesive between the paper lamination and the coextrusion layer comprises coating one of a group consisting of the paper lamination, the coextrusion layer, and the paper lamination and the coextrusion layer; and
said method further comprises the step, after said step of disposing the second adhesive between the paper lamination and the coextrusion layer, of compressing the paper lamination and the coextrusion layer together through a second set of nip rollers.

Clause 52. The method of Clause 30, further comprising the step of drying the paper lamination and the coextrusion layer after said step of disposing the second adhesive between the paper lamination and the coextrusion layer.

Clause 53. The method of Clause 30, further comprising the step of rolling the paper lamination and the coextrusion layer into a fifth spool after said step of disposing the second adhesive between the paper lamination and the coextrusion layer.

Clause 54. A method for producing a paper base web structure, said method comprising the steps of:
providing outer and inner paper layers;
extrusion laminating the outer and inner paper layers with an extruded polyethylene layer to form a paper lamination;
chilling the paper lamination;
coating the inner paper layer of the paper lamination with a polymer coextrusion coating to form the paper base web structure; and
chilling the paper base web structure.

Clause 55. The method of Clause 54, wherein said step of extrusion laminating comprises the steps of:
passing a polyethylene resin through an extruder and through an extrusion die as a melt curtain.

Clause 56. The method of Clause 54, wherein said step of providing the coextrusion coating comprises the steps of:
supplying polyethylene, a tie resin, and EVOH to a coextrusion feed block to form a PE-EVOH-PE multilayer coextrusion; and
bringing the PE-EVOH-PE multilayer coextrusion onto the paper lamination.

Clause 57 A thermoformable paper base web comprising:
an outer paper layer having a first surface and a second surface opposite the first surface, wherein the first surface of the outer paper layer defines an exterior-facing surface of the paper base web;
a first bonding layer directly adjacent to the second surface of the outer paper layer;
an inner paper layer having a first surface and a second surface opposite the first surface, the first surface of the inner paper layer directly adjacent to the first bonding layer;
a polymer layer having a first surface and a second surface opposite the first surface, wherein the second surface of the polymer layer defines an interior-facing surface of the paper base web, and wherein the first surface of the polymer layer is attached directly to:
the second surface of the inner paper layer; or
a second adhesive layer, wherein the second adhesive layer is attached directly to the second surface of the inner paper layer;
wherein said outer and inner paper layers together comprise at least 80% by weight of the paper base web and less than 100% by weight of the paper base web.

Clause 58. The thermoformable paper base web of Clause 57, wherein the polymer layer comprises a barrier film.

Clause 59. The thermoformable paper base web of Clause 57, wherein the outer paper layer and the inner paper layer, which may be the same or different, each comprise paper having a basis weight in the range of 50 GSM to 300 GSM.

Clause 60. The thermoformable paper base web of Clause 57, wherein: the first surface of the polymer layer is attached directly to the second adhesive layer.

Clause 61. The thermoformable paper base web of Clause 60, wherein the polymer layer comprises a coextruded film comprising a first polyethylene layer, a second polyethylene layer, and an ethylene-vinyl alcohol copolymer (EVOH) layer disposed intermediate the first and second polyethylene layers.

Clause 62. The thermoformable paper base web of Clause 60, wherein the first adhesive layer is selected from the group consisting of a high viscosity adhesive having a viscosity in the range of 300 cP to 500,000 cP at 50 degrees C., a high solids content adhesive having a solids content in the range of 15% to 100% by weight, or both.

Clause 63. The thermoformable paper base web of Clause 57, wherein the first surface of the polymer layer is attached directly to the second surface of the inner paper layer.

Clause 64. The thermoformable paper base web of Clause 63, wherein the first adhesive layer is an extruded polyolefin layer bonding the second surface of the outer paper layer to the first surface of the inner paper layer.

Clause 65. The thermoformable paper base web of Clause 63, wherein the polymer layer comprises a barrier layer.

Clause 66. The thermoformable paper base web of Clause 63, wherein the polymer layer comprises a coextrusion coating comprising a first polyethylene layer, a second polyethylene layer, and an ethylene-vinyl alcohol copolymer (EVOH) layer disposed intermediate the first and second polyethylene layers.

Clause 67. The thermoformable paper base web of Clause 57, wherein the paper base web is thermoformable to a depth of between 1 mm to 153 mm.

Clause 68. A method for producing a paper base web, comprising:
laminating an outer paper layer to an inner paper layer with a first adhesive layer, the outer paper layer having a first surface and a second surface opposite the first surface, wherein the first surface of the outer paper layer defines an exterior-facing surface of the paper base web, and wherein the first adhesive layer is directly adjacent to the second surface of the outer paper layer;
the inner paper having a first surface and a second surface opposite the first surface, the first surface of the inner paper layer directly adjacent to the first adhesive layer;
attaching a polymer layer to the second surface of the inner paper layer, the polymer layer having a first surface and a second surface opposite the first surface, wherein the second surface of the polymer layer defines an interior-facing surface of the paper base web, and wherein the first surface of the polymer layer is attached directly to:
the second surface of the inner paper layer; or
a second adhesive layer, wherein the second adhesive layer is attached directly to the second surface of the inner paper layer;
wherein said outer and inner paper layers together comprise at least 80% by weight of the paper base web and less than 100% by weight of the paper base web.

Clause 69. The method of Clause 68, wherein the polymer layer comprises a barrier film.

Clause 70. The method of Clause 68, wherein the outer paper layer and the inner paper layer, which may be the same of different, each comprise paper having a basis weight in the range of 50 GSM to 300 GSM.

Clause 71. The method of Clause 68, wherein the step of attaching the polymer layer to the second surface of the inner paper layer comprises adhesively laminating the first surface of the polymer layer to the second surface of the inner paper layer.

Clause 72. The method of Clause 71, wherein the polymer layer comprises a coextruded film comprising a first polyethylene layer, a second polyethylene layer, and an ethylene-vinyl alcohol copolymer (EVOH) layer disposed intermediate the first and second polyethylene layers.

Clause 73. The method of Clause 71, wherein the first adhesive layer is selected from the group consisting of a high viscosity adhesive having a viscosity in the range of 300 cP to 500,000 cP at 50 degrees C., a high solids content adhesive having a solids content in the range of 15% to 100% by weight, or both.

Clause 74. The method of Clause 68, wherein the first surface of the polymer layer is attached directly to the second surface of the inner paper layer.

Clause 75. The method of Clause 74, wherein the first adhesive layer is an extruded polyolefin layer bonding the second surface of the outer paper layer to the first surface of the inner paper layer and wherein the step of laminating an outer paper layer to an inner paper layer is performed by extrusion lamination.

Clause 76. The method of Clause 74, wherein the polymer layer is attached directly to the second surface of the inner paper layer by extrusion coating or coextrusion coating.

Clause 77. The method of Clause 76, wherein the polymer layer is attached directly to the second surface of the inner paper layer by coextrusion coating a first polyethylene layer, a second polyethylene layer, and an ethylene-vinyl alcohol copolymer (EVOH) layer disposed intermediate the first and second polyethylene layers.

Clause 78. The method of Clause 68, further comprising modifying one or more of the second surface of the outer paper layer, the first surface of the inner paper layer, the second surface of the inner paper layer, and the inner surface of the polymer layer with a surface treatment selected from the group consisting of flame treatment, corona treatment, ozone treatment, and plasma treatment.

Clause 79. A thermoformed packaging article formed from the paper base web or method of any of the preceding Clauses.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A thermoformable paper base web, comprising:
an outer paper layer having a first surface and a second surface opposite the first surface, wherein the first surface of the outer paper layer defines an exterior-facing surface of the paper base web;
an inner paper layer having a first surface and a second surface opposite the first surface, the first surface of the inner paper layer laminated to the second surface of the outer paper layer;
a first bonding layer between the outer paper layer and inner paper layer, the first bonding layer joining the second surface of the outer paper layer to the first surface of the inner paper layer;
a polymer layer having a first surface and a second surface opposite the first surface, wherein the second surface of the polymer layer defines an interior-facing surface of the paper base web, and wherein the first surface of the polymer layer is joined to the second surface of the inner paper layer; and
said outer and inner paper layers together comprise at least 80% by weight of the thermoformable paper base web and less than 100% by weight of the thermoformable paper base web.

2. The thermoformable paper base web of claim 1, wherein the first bonding layer is attached directly to the second surface of the outer paper layer and the first surface of the inner paper layer.

3. The thermoformable paper base web of claim 1, wherein the first bonding layer is selected from the group consisting of an adhesive layer and an extruded resin layer.

4. The thermoformable paper base web of claim 1, wherein the polymer layer is selected from the group consisting of monolayer film and a multilayer film.

5. The thermoformable paper base web of claim 1, wherein the polymer layer is attached directly to the second surface of the inner paper layer.

6. The thermoformable paper base web of claim 1, further comprising:
a second bonding layer between the inner paper layer and the polymer layer, the second bonding layer joining the second surface of the inner paper layer to the first surface of the polymer layer.

7. The thermoformable paper base web of claim 6, wherein the second bonding layer is attached directly to the second surface of the inner paper layer and the first surface of the polymer layer.

8. The thermoformable paper base web of claim 6, wherein the second bonding layer is an adhesive layer and the inner paper layer is laminated with the polymer layer via the adhesive layer.

9. The thermoformable paper base web of claim 1, wherein the polymer layer is selected from the group consisting of a barrier film layer and a nonbarrier film layer.

10. The thermoformable paper base web of claim 1, wherein the outer paper layer and the inner paper layer, which may be the same or different, each comprise paper having a basis weight in the range of 50 GSM to 300 GSM.

11. The thermoformable paper base web of claim 1, wherein the polymer layer is selected from the group consisting of:
a first coextruded film comprising a first polyolefin layer, a second polyolefin layer, and a first barrier layer disposed intermediate the first and second polyolefin layers, wherein the first barrier layer is formed of a material selected from the group consisting of ethylene-vinyl alcohol copolymer (EVOH), polyvinylidene di-chloride (PVcD), polyamide, and polyvinyl alcohol (PVOH); and
a second coextruded film comprising a second barrier layer having a barrier outer surface coupled to the second surface of the inner paper layer and a barrier inner surface opposite the barrier outer surface, and a third polyolefin layer coupled to the barrier inner surface.

12. The thermoformable paper base web of claim 11, wherein the first and second barrier layers comprise EVOH and the first, second, and third polyolefin layers, which may be the same or different, comprise a polyethylene-based polymer.

13. The thermoformable paper base web of claim 11, wherein the first bonding layer is selected from the group consisting of:
an adhesive layer formed of an adhesive selected from the group consisting of a high viscosity adhesive having a viscosity in the range of 300 cP to 500,000 cP at 50 degrees C.;
a high solids content adhesive having a solids content in the range of 15% to 100% by weight; and
an extruded polyolefin resin layer.

14. The thermoformable paper base web of claim 11, wherein the first bonding layer is selected from the group consisting of:
a third coextruded film comprising a fourth polyolefin layer, a fifth polyolefin layer, and a third barrier layer disposed intermediate the fourth and fifth polyolefin layers, wherein the third barrier layer is formed of a material selected from the group consisting of ethylene-vinyl alcohol copolymer (EVOH), polyvinylidene di-chloride (PVcD), polyamide, and polyvinyl alcohol (PVOH); and
a fourth coextruded film comprising a fourth barrier layer having a barrier inner surface coupled to the first surface of the inner paper layer and a barrier outer surface opposite the barrier inner surface, and a sixth polyolefin layer coupled to the barrier outer surface and the second surface of the outer paper layer.

15. The thermoformable paper base web of claim 14, wherein the third and fourth barrier layers comprise EVOH and the fourth, fifth, and sixth polyolefin layers, which may be the same or different, comprise a polyethylene-based polymer.

16. The thermoformable paper base web of claim 1, wherein the paper base web is thermoformable to a depth of between 1 mm to 153 mm.

17. The thermoformable paper base web of claim 1, wherein said outer and inner paper layers together comprise at least 85% by weight of the thermoformable paper base web and less than 100% by weight of the thermoformable paper base web.

18. The thermoformable paper base web of claim 1, wherein said outer and inner paper layers together comprise at least 90% by weight of the thermoformable paper base web and less than 100% by weight of the thermoformable paper base web.

19. The thermoformable paper base web of claim 1, wherein said outer and inner paper layers together comprise at least 95% by weight of the thermoformable paper base web and less than 100% by weight of the thermoformable paper base web.

20. A method for producing a thermoformable paper base web, comprising:
laminating an outer paper layer to an inner paper layer with a first bonding layer therebetween, the outer paper layer having a first surface and a second surface opposite the first surface, wherein the first surface of the outer paper layer defines an exterior-facing surface of the paper base web;
the inner paper layer having a first surface and a second surface opposite the first surface, the first surface of the inner paper layer facing second surface of the outer paper layer; and
attaching a polymer layer to the second surface of the inner paper layer, the polymer layer having a first surface and a second surface opposite the first surface, wherein the first surface of the polymer layer is joined to the second surface of the inner paper layer and the second surface of the polymer layer defines an interior-facing surface of the paper base web;
wherein the outer and inner paper layers together comprise at least 80% by weight of the thermoformable paper base web and less than 100% by weight of the thermoformable paper base web.

21. The method of claim 20, wherein the first bonding layer is attached directly to the second surface of the outer paper layer and the first surface of the inner paper layer.

22. The method of claim 20, wherein the first bonding layer is selected from the group consisting of an adhesive layer and an extruded resin layer.

23. The method of claim 20, wherein the first bonding layer is selected from the group consisting of:
a high viscosity adhesive having a viscosity in the range of 300 cP to 500,000 cP at 50 degrees C.;
a high solids content adhesive having a solids content in the range of 15% to 100% by weight; and
an extruded polyolefin resin layer.

24. The method of claim 23, wherein the step of attaching the polymer layer to the second surface of the inner paper layer is performed by a process selected from the group consisting of adhesive lamination and extrusion lamination.

25. The method of claim 20, wherein the step of attaching the polymer layer to the second surface of the inner paper layer includes applying a second bonding layer between the inner paper layer and the polymer layer, the second bonding layer joining the second surface of the inner paper layer to the first surface of the polymer layer.

26. The method of claim 25, wherein the second bonding layer is selected from the group consisting of an adhesive layer and an extruded resin layer.

27. The method of claim 25, wherein the second bonding layer is selected from the group consisting of:
a high viscosity adhesive having a viscosity in the range of 300 cP to 500,000 cP at 50 degrees C.;
a high solids content adhesive having a solids content in the range of 15% to 100% by weight; and
an extruded polyolefin resin layer.

28. The method of claim 26 wherein the second bonding layer is attached directly to the second surface of the inner paper layer and the first surface of the polymer layer.

29. The method of claim 28 wherein the polymer layer is applied to the second surface of the inner paper layer using a method selected from the group consisting of an extrusion coating process and a coextrusion coating process.

30. The method of claim 20, wherein the polymer layer is selected from the group consisting of monolayer film and a multilayer film.

31. The method of claim 20, wherein the polymer layer is selected from the group consisting of a barrier film layer and a nonbarrier film layer.

32. The method of claim 20, wherein the polymer layer is selected from the group consisting of a barrier film layer and a nonbarrier film layer.

33. The method of claim 20, wherein the polymer layer is selected from the group consisting of:
a first coextruded film comprising a first polyolefin layer, a second polyolefin layer, and a first barrier layer disposed intermediate the first and second polyolefin layers, wherein the first barrier layer is formed of a material selected from the group consisting of ethylene-vinyl alcohol copolymer (EVOH), polyvinylidene di-chloride (PVcD), polyamide, and polyvinyl alcohol (PVOH); and
a second coextruded film comprising a second barrier layer having a barrier outer surface coupled to the second surface of the inner paper layer and a barrier inner surface opposite the barrier outer surface, and a third polyolefin layer coupled to the barrier inner surface.

34. The method of claim 33, wherein the first and second barrier layers comprise EVOH and the first, second, and third polyolefin layers, which may be the same or different, comprise a polyethylene-based polymer.

35. The method of claim 33, wherein the first bonding layer is selected from the group consisting of:
an adhesive layer formed of an adhesive selected from the group consisting of a high viscosity adhesive having a viscosity in the range of 300 cP to 500,000 cP at 50 degrees C.;
a high solids content adhesive having a solids content in the range of 15% to 100% by weight; and
an extruded polyolefin resin layer.

36. The method of claim 33, wherein the first bonding layer is selected from the group consisting of:
a third coextruded film comprising a fourth polyolefin layer, a fifth polyolefin layer, and a third barrier layer disposed intermediate the fourth and fifth polyolefin layers, wherein the third barrier layer is formed of a material selected from the group consisting of ethylene-vinyl alcohol copolymer (EVOH), polyvinylidene di-chloride (PVcD), polyamide, and polyvinyl alcohol (PVOH); and
a fourth coextruded film comprising a fourth barrier layer having a barrier inner surface coupled to the first surface of the inner paper layer and a barrier outer surface opposite the barrier inner surface, and a sixth polyolefin layer coupled to the barrier outer surface and the second surface of the outer paper layer.

37. The method of claim 36, wherein the third and fourth barrier layers comprise EVOH and the fourth, fifth, and sixth polyolefin layers, which may be the same or different, comprise a polyethylene-based polymer.

38. The method of claim 20, further comprising modifying one or more of the second surface of the outer paper layer, the first surface of the inner paper layer, the second surface of the inner paper layer, and the inner surface of the polymer layer with a surface treatment selected from the group consisting of flame treatment, corona treatment, ozone treatment, and plasma treatment.

39. A thermoformed packaging article formed from the thermoformable paper base web of claim 1.

40. A thermoformed packaging article formed by the method of claim 20.
